(19) United States
(12) Patent Application Publication
(10) Pub. No.: US 2025/0004721 A1
(43) Pub. Date: Jan. 2, 2025

(54) MULTIPLYING AND ADDING SMALL-EXPONENT FLOATING-POINT FORMAT DATA ELEMENTS WITH INTEGER ADDITION

(71) Applicants: Simon Rubanovich, Haifa (IL); Amit Gradstein, Binyamina (IL); Sagi Meller, Zichron Yaakov (IL); Uri Reuven Tassa, Tel Aviv (IL); Dan Baum, Haifa (IL)

(72) Inventors: Simon Rubanovich, Haifa (IL); Amit Gradstein, Binyamina (IL); Sagi Meller, Zichron Yaakov (IL); Uri Reuven Tassa, Tel Aviv (IL); Dan Baum, Haifa (IL)

(21) Appl. No.: 18/830,262

(22) Filed: Sep. 10, 2024

(51) Int. Cl. G06F 7/556

(52) U.S. Cl. CPC G06F 7/556

(57) ABSTRACT

A method of an aspect includes multiplying pairs of corresponding small-exponent floating-point data elements to generate corresponding small-exponent floating-point products. The small-exponent floating-point data elements and the small-exponent floating-point products each have no more than six exponent bits. The method also includes converting the small-exponent floating-point products to signed fixed-point products and accumulating the signed fixed-point products, and an optional signed fixed-point accumulation value, by fixed-point addition to generate a signed fixed-point accumulation value. Other methods, processors, systems, and instructions are disclosed.

### BACKGROUND

### Background Information

Matrices are increasingly important in many computing tasks such as machine learning and other bulk data processing. Deep Learning is a class of machine learning algorithms. Deep learning architectures, such as deep neural networks, have been applied to fields including computer vision, speech recognition, natural language processing, audio recognition, social network filtering, machine translation, bioinformatics, and drug design.

### BRIEF DESCRIPTION OF THE DRAWINGS

Various examples in accordance with the present disclosure will be described with reference to the drawings, in which:

FIG. 1A illustrates an embodiment of configured tiles.

FIG. 1B illustrates an embodiment of configured tiles.

FIG. 2 illustrates several examples of matrix storage.

FIG. 3 illustrates an embodiment of a system utilizing a matrix (tile) operations accelerator.

FIGS. 4 and 5 show different embodiments of how memory is shared using a matrix operations accelerator.

FIG. 6 illustrates an embodiment of matrix multiply accumulate operation using tiles (“TMMA”).

FIG. 7 illustrates an embodiment of a subset of the execution of an iteration of a chained fused multiply accumulate instruction.

FIG. 8 illustrates an embodiment of a subset of the execution of an iteration of a chained fused multiply accumulate instruction.

FIG. 9 illustrates an embodiment of a subset of the execution of an iteration of a chained fused multiply accumulate instruction.

FIG. 10 illustrates an embodiment of a subset of the execution of an iteration of chained fused multiply accumulate instruction.

FIG. 11 illustrates power-of-two sized SIMD implementations wherein the accumulators use input sizes that are larger than the inputs to the multipliers according to an embodiment.

FIG. 12 illustrates an embodiment of a system utilizing matrix operations circuitry.

FIG. 13 illustrates an embodiment of a processor core pipeline supporting matrix operations using tiles.

FIG. 14 illustrates an embodiment of a processor core pipeline supporting matrix operations using tiles.

FIG. 15 illustrates an example of a matrix expressed in row major format and column major format.

FIG. 16 illustrates an example of usage of matrices (tiles).

FIG. 17 illustrates an embodiment of a method of usage of matrices (tiles).

FIG. 18 illustrates support for configuration of the usage of tiles according to an embodiment.

FIG. 19 illustrates an embodiment of a description of the matrices (tiles) to be supported.

FIGS. 20(A)-(D) illustrate examples of register(s).

FIG. 21 is a block flow diagram of an embodiment of a method of multiplying and adding small-exponent floating-point format data elements.

FIG. 22 is a block diagram of an embodiment of a processor.

FIG. 23 is a block diagram of an example embodiment of multiplication and addition/accumulation circuitry to multiply and add/accumulate four pairs of FP8 floating-point data elements.

FIG. 24 is a block diagram of an example embodiment of a floating-point multiplier.

FIG. 25 is a block diagram of an example embodiment of a 64-bit alignment shifter.

FIG. 26 is a block diagram of a detailed example embodiment of integer addition and/or accumulation circuitry.

FIG. 27 illustrates an example computing system.

FIG. 28 illustrates a block diagram of an example processor and/or System on a Chip (SoC) that may have one or more cores and an integrated memory controller.

FIG. 29(A) is a block diagram illustrating both an example in-order pipeline and an example register renaming, out-of-order issue/execution pipeline according to examples.

FIG. 29(B) is a block diagram illustrating both an example in-order architecture core and an example register renaming, out-of-order issue/execution architecture core to be included in a processor according to examples.

FIG. 30 illustrates examples of execution unit(s) circuitry.

FIG. 31 is a block diagram of a register architecture according to some examples.

FIG. 32 illustrates examples of an instruction format.

FIG. 33 illustrates examples of an addressing information field.

FIG. 34 illustrates examples of a first prefix.

FIGS. 35(A)-(D) illustrate examples of how the R, X, and B fields of the first prefix in FIG. 34 are used.

FIGS. 36(A)-(B) illustrate examples of a second prefix.

FIG. 37 illustrates examples of a third prefix.

FIG. 38 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to methods, apparatus, systems, and non-transitory computer-readable storage media for multiplying and adding small-exponent floating-point format data elements with integer addition. In the following description, numerous specific details are set forth (e.g., specific instruction operations, data formats, processor configurations, microarchitectural details, sequences of operations, etc.). However, embodiments may be practiced without these specific details. In other instances, well-known circuits, structures, and techniques have not been shown in detail to avoid obscuring the understanding of the description.

In many mainstream processors, handling matrices is a difficult and/or instruction intensive task. For example, rows of a matrix could be put into a plurality of packed data (e.g., SIMD or vector) registers and then operated on individually. For example, an add two 8×2 matrices may require a load or gather into four packed data registers depending upon data sizes. Then a first add of packed data registers corresponding to a first row from each matrix is performed and a second add of packed data registers corresponding to a second row from each matrix is performed. Then the resulting packed data registers are scattered back to memory. While for small matrices this scenario may be acceptable, it is often not acceptable with larger matrices.

### Discussion

Described herein are mechanisms to support matrix operations in computer hardware such as central processing units (CPUs), graphic processing units (GPUs), and accelerators. The matrix operations utilize 2-dimensional (2-D) data structures representing one or more packed regions of memory such as registers. Throughout this description, these 2-D data structures are also sometimes referred to as tiles. Note that a matrix may be smaller than a tile (use less than all of a tile) or utilize a plurality of tiles (the matrix is larger than the size of any one tile). Throughout the description, matrix (tile) language is used to indicate operations performed using tiles that impact a matrix; whether that matrix is larger than any one tile is not typically relevant.

Each tile may be acted upon by different operations such as those that are detailed herein and include, but are not limited to: matrix (tile) multiplication, tile add, tile subtract, tile diagonal, tile zero, tile transform, tile dot product, tile broadcast, tile row broadcast, tile column broadcast, tile multiplication, tile multiplication and accumulation, tile move, etc. Additionally, support for operators such as the use of a scale and/or bias may be used with these operations or in support of non-numeric applications in the future, for instance, OpenCL “local memory,” data compression/decompression, etc.

Portions of storage (such as memory (non-volatile and volatile), registers, cache, etc.) are arranged into tiles of different horizontal and vertical dimensions. For example, a tile may have horizontal dimension of 4 (e.g., four rows of a matrix) and a vertical dimension of 8 (e.g., 8 columns of the matrix). Typically, the horizontal dimension is related to element sizes (e.g., 2-, 4-, 8-, 16-, 32-, 64-, 128-bit, etc.). Multiple datatypes (single precision floating-point, double precision floating-point, integer, etc.) may be supported.

### Exemplary Usage of Configured Tiles

In some embodiments, tile parameters can be configured. For example, a given tile may be configured to provide tile options. Exemplary tile options include but are not limited to a number of rows of the tile, a number of columns of the tile, whether the tile is VALID, and whether the tile consists of a PAIR of equal-sized tiles.

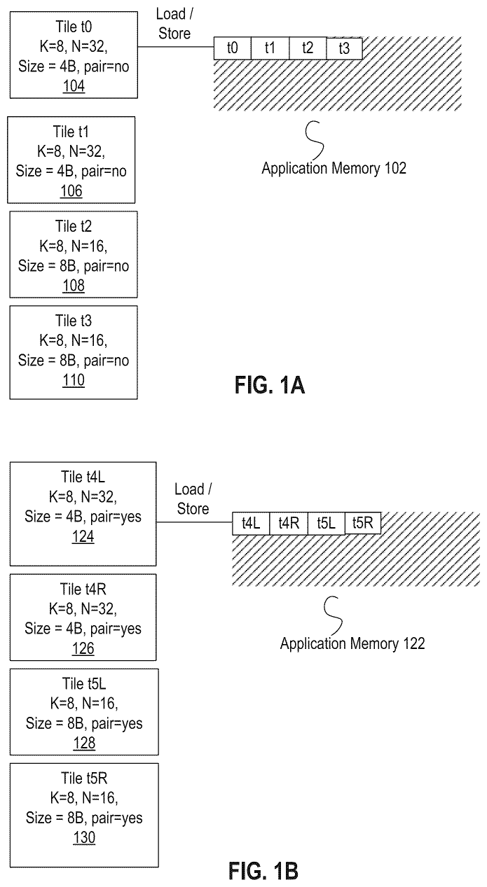

FIG. 1A illustrates an embodiment of configured tiles. As shown, 4 kB of application memory 102 have stored thereon 4 1 KB titles, tile t0 104, tile t1 106, tile t2 108, and tile t3 110. In this example, the 4 tiles do not consist of pairs, and each have elements arranged in rows and columns. Tile t0 104 and tile t1 106 have K rows and N columns of 4-byte elements (e.g., single precision data), where K equals 8 and N=32. Tile t2 108 and tile t3 110 have K rows and N/2 columns of 8-byte elements (e.g., double precision data). As the double precision operands are twice the width of single precision, this configuration is consistent with a palette, used to provide tile options, supplying at least 4 names with total storage of at least 4 kB. In operation, the tiles can be loaded from and stored to memory using load and store operations. Depending upon the instruction encoding scheme used, the amount of available application memory, as well as the size, number, and configuration of available tiles varies.

FIG. 1B illustrates an embodiment of configured tiles. As shown, 4 KB of application memory 122 have stored thereon 2 pairs of 1kB-titles, the first pair being tile t4L 124 and tile t4R 126, and the second pair being tile t5L 128 and tile t5R 130. As shown the pairs of tiles are divided into a left tile and a right tile. In other embodiments, the pair of tiles are divided into an even tile and an odd tile. In this example, the 4 tiles each have elements arranged in rows and columns. Tile t4L 124 and tile t4R 126 have K rows and N columns of 4-byte elements (e.g., single precision floating-point data), where K equals 8 and N equals 32. Tile t5L 128 and tile t5R 130 have K rows and N/2 columns of 8-byte elements (e.g., double precision floating-point data). As the double precision operands are twice the width of single precision, this configuration is consistent with a palette, used to provide tile options, supplying at least 2 names with total storage of at least 4 KB. The four tiles of FIG. 1A use 4 names, each naming a 1 kB tile, whereas the 2 pairs of tiles in FIG. 1B can use 2 names to specify the paired tiles. In some embodiments, tile instructions accept a name of a paired tile as an operand. In operation, the tiles can be loaded from and stored to memory using load and store operations. Depending upon the instruction encoding scheme used, the amount of available application memory, as well as the size, number, and configuration of available tiles varies.

In some embodiments, tile parameters are definable. For example, a “palette” is used to provide tile options. Exemplary options include, but are not limited to the number of tile names, the number of bytes in a row of storage, the number of rows and columns in a tile, etc. For example, a maximum “height” (number of rows) of a tile may be defined as:

Tile Max Rows=Architected Storage/(The Number of Palette Names*The Number of Bytes per row).

As such, an application can be written such that a fixed usage of names will be able to take advantage of different storage sizes across implementations.

Configuration of tiles is done using a matrix (tile) configuration (“TILECONFIG”) instruction, where a particular tile usage is defined in a selected palette. This declaration includes the number of tile names to be used, the requested number of rows and columns per name (tile), and, in some embodiments, the requested datatype of each tile. In some embodiments, consistency checks are performed during the execution of a TILECONFIG instruction to determine that it matches the restrictions of the palette entry.

### Exemplary Tile Storage Types

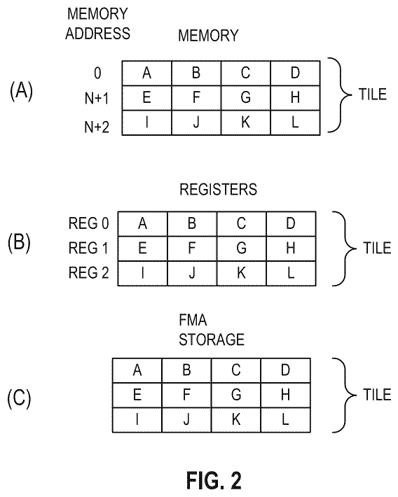

FIG. 2 illustrates several examples of matrix storage. In (A), a tile is stored in memory. As shown, each “row” consists of four packed data elements. To get to the next “row,” a stride value is used. Note that rows may be consecutively stored in memory. Strided memory accesses allow for access of one row to then next when the tile storage does not map the underlying memory array row width.

Tile loads from memory and stores to memory are typically strided accesses from the application memory to packed rows of data. Exemplary TILELOAD and TILESTORE instructions, or other instruction references to application memory as a TILE operand in load-op instructions, are, in some embodiments, restartable to handle (up to) 2*rows of page faults, unmasked floating-point exceptions, and/or interrupts per instruction.

In (B), a matrix is stored in a tile comprised of a plurality of registers such as packed data registers (single instruction, multiple data (SIMD) or vector registers). In this example, the tile is overlaid on three physical registers. Typically, consecutive registers are used, however, this need not be the case.

In (C), a matrix is stored in a tile in non-register storage accessible to a fused multiple accumulate (FMA) circuit used in tile operations. This storage may be inside of an FMA, or adjacent to it. Additionally, in some embodiments, discussed below, the storage may be for a data element and not an entire row or tile.

The supported parameters for the TMMA architecture are reported via CPUID. In some embodiments, the list of information includes a maximum height and a maximum SIMD dimension. Configuring the TMMA architecture requires specifying the dimensions for each tile, the element size for each tile and the palette identifier. This configuration is done by executing the TILECONFIG instruction.

Successful execution of a TILECONFIG instruction enables subsequent TILE operators. A TILERELEASEALL instruction clears the tile configuration and disables the TILE operations (until the next TILECONFIG instructions executes). In some embodiments, XSAVE, XSTORE, etc. are used in context switching using tiles. In some embodiments, 2 XCR0 bits are used in XSAVE, one for TILECONFIG metadata and one bit corresponding to actual tile payload data. TILECONFIG not only configures the tile usage, but also sets a state variable indicating that the program is in a region of code with tiles configured. An implementation may enumerate restrictions on other instructions that can be used with a tile region such as no usage of an existing register set, etc.

Exiting a tile region is typically done with the TILERELEASEALL instruction. It takes no parameters and swiftly invalidates all tiles (indicating that the data no longer needs any saving or restoring) and clears the internal state corresponding to being in a tile region.

In some embodiments, tile operations will zero any rows and any columns beyond the dimensions specified by the tile configuration. For example, tile operations will zero the data beyond the configured number of columns (factoring in the size of the elements) as each row is written. For example, with 64-byte rows and a tile configured with 10 rows and 12 columns, an operation writing FP32 elements would write each of the first 10 rows with 12*4 bytes with output/result data and zero the remaining 4*4 bytes in each row. Tile operations also fully zero any rows after the first 10 configured rows. When using IK tile with 64-byte rows, there would be 16 rows, so in this example, the last 6 rows would also be zeroed.

In some embodiments, a context restore instruction (e.g., XRSTOR), when loading data, enforces that the data beyond the configured rows for a tile will be maintained as zero. If there is no valid configuration, all rows are zeroed. XRSTOR of tile data can load garbage in the columns beyond those configured. It should not be possible for XRSTOR to clear beyond the number of columns configured because there is not an element width associated with the tile configuration.

Context save (e.g., XSAVE) exposes the entire TILE storage area when writing it to memory. If XRSTOR loaded garbage data into the rightmost part of a tile, that data will be saved by XSAVE. XSAVE will write zeros for rows beyond the number specified for each tile.

In some embodiments, tile instructions are restartable. The operations that access memory allow restart after page faults. The computational instructions that deal with floating-point operations also allow for unmasked floating-point exceptions, with the masking of the exceptions controlled by a control and/or status register.

To support restarting instructions after these events, the instructions store information in the start registers detailed below.

### Matrix (Tile) Operation Systems

### Exemplary Hardware Support

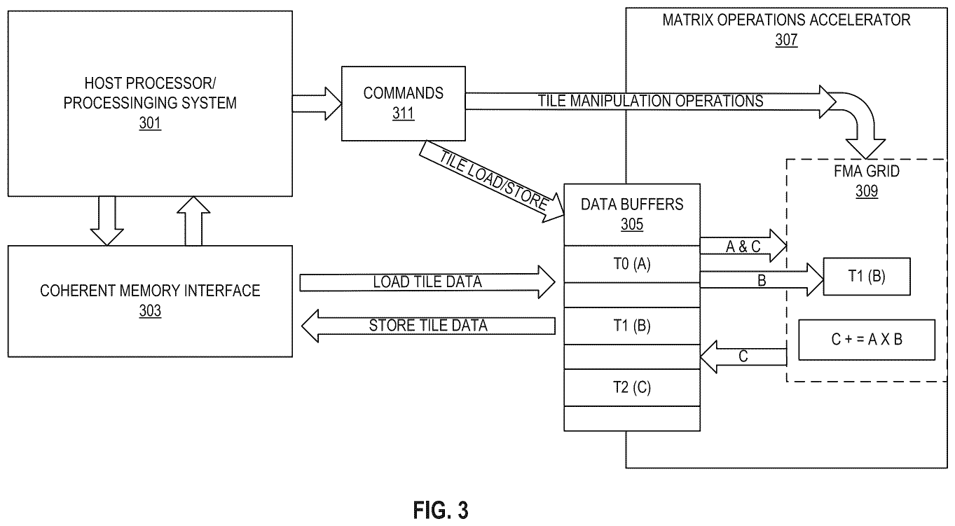

FIG. 3 illustrates an embodiment of a system utilizing a matrix (tile) operations accelerator. In this illustration, a host processor/processing system 301 communicates commands 311 (e.g., matrix manipulation operations such as arithmetic or matrix manipulation operations, or load and store operations) to a matrix operations accelerator 307. However, this is shown this way for discussion purposes only. As detailed later, this accelerator 307 may be a part of a processing core. Typically, commands 311 that are tile manipulation operator instructions will refer to tiles as register-register (“reg-reg”) or register-memory (“reg-mem”) format. Other commands such as TILESTORE, TILELOAD, TILECONFIG, etc., do not perform data operations on a tile. Commands may be decoded instructions (e.g., micro-ops) or macro-instructions for the accelerator 307 to handle.

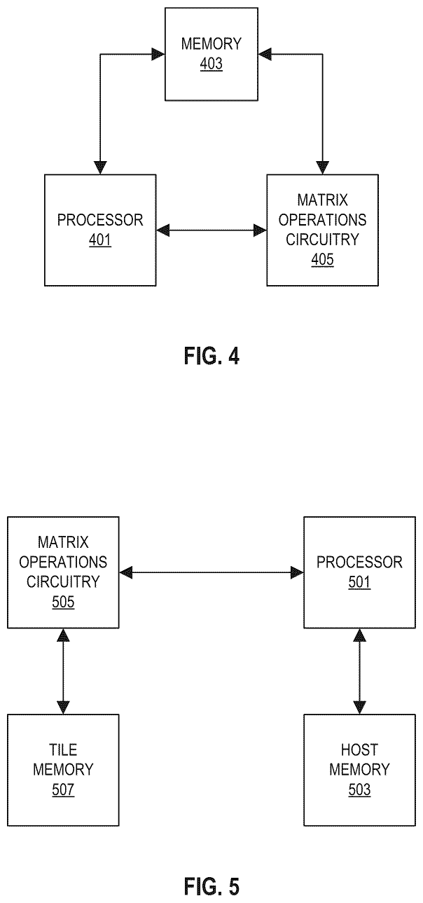

In this example, a coherent memory interface 303 is coupled to the host processor/processing system 301 and matrix operations accelerator 307 such that they can share memory. FIGS. 4 and 5 show different embodiments of how memory is shared using a matrix operations accelerator. As shown in FIG. 4, the host processor 401 and matrix operations accelerator circuitry 405 share the same memory 403. FIG. 5 illustrates an embodiment where the host processor 501 and matrix operations accelerator 505 do not share memory but can access each other's memory. For example, processor 501 can access tile memory 507 and utilize its host memory 503 as normal. Similarly, the matrix operations accelerator 505 can access host memory 503, but more typically uses its own memory 507. Note these memories may be of different types.

In some embodiments, tiles are supported using an overlay over physical registers. For example, a tile may utilize 16 1,024-bit registers, 32 512-bit registers, etc. depending on the implementation. In some embodiments, the matrix operations utilize 2-dimensional (2-D) data structures representing one or more packed regions of memory such as registers. Throughout this description, these 2-D data structures are sometimes referred to as tiles or tile registers.

In some embodiments, the matrix operations accelerator 307 includes a plurality of FMAs 309 coupled to data buffers 305 (in some implementations, one or more of these buffers 305 are stored in the FMAs of the grid as shown). The data buffers 305 buffer tiles loaded from memory and/or tiles to be stored to memory (e.g., using a tileload or tilestore instruction). Data buffers may be, for example, a plurality of registers. Typically, these FMAs are arranged as a grid of chained FMAs 309 which can read and write tiles. In this example, the matrix operations accelerator 307 is to perform a matrix multiply operation using tiles T0, T1, and T2. At least one of tiles is housed in the FMA grid 309. In some embodiments, all tiles in an operation are stored in the FMA grid 309. In other embodiments, only a subset is stored in the FMA grid 309. As shown, T1 is housed and T0 and T2 are not. Note that A, B, and C refer to the matrices of these tiles which may or may not take up the entire space of the tile.

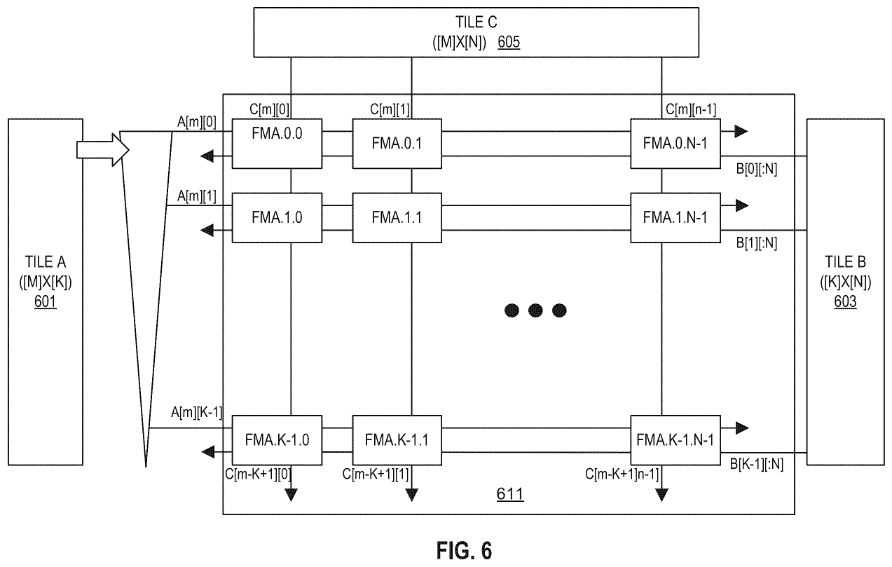

FIG. 6 illustrates an embodiment of matrix multiply accumulate operation using tiles (“TMMA”).

The number of rows in the matrix (TILE A 601) matches the number of serial (chained) FMAs comprising the computation's latency. An implementation is free to recirculate on a grid of smaller height, but the computation remains the same.

The source/destination vector comes from a tile of N rows (TILE C 605) and the grid of FMAs 611 performs N vector-matrix operations resulting in a complete instruction performing a matrix multiplication of tiles. Tile B 603 is the other vector source and supplies “broadcast” terms to the FMAs in each stage.

In operation, in some embodiments, the elements of matrix B (stored in a tile B 603) are spread across the rectangular grid of FMAs. Matrix B (stored in tile A 601) has its elements of a row transformed to match up with the columnar dimension of the rectangular grid of FMAs. At each FMA in the grid, an element of A and B are multiplied and added to the incoming summand (from above in the Figure) and the outgoing sum is passed to the next row of FMAs (or the final output).

The latency of a single step is proportional to K (row height of matrix B) and dependent TMMAs typically have enough source-destination rows (either in a single tile or across tile) to hide that latency. An implementation may also split the SIMD (packed data element) dimension M (row height of matrix A) across time steps, but this simply changes the constant that K is multiplied by. When a program specifies a smaller K than the maximum enumerated by the TMACC, an implementation is free to implement this with “masking” or “early outs.”

The latency of an entire TMMA is proportional to N*K. The repeat rate is proportional to N. The number of MACs per TMMA instruction is N*K*M.

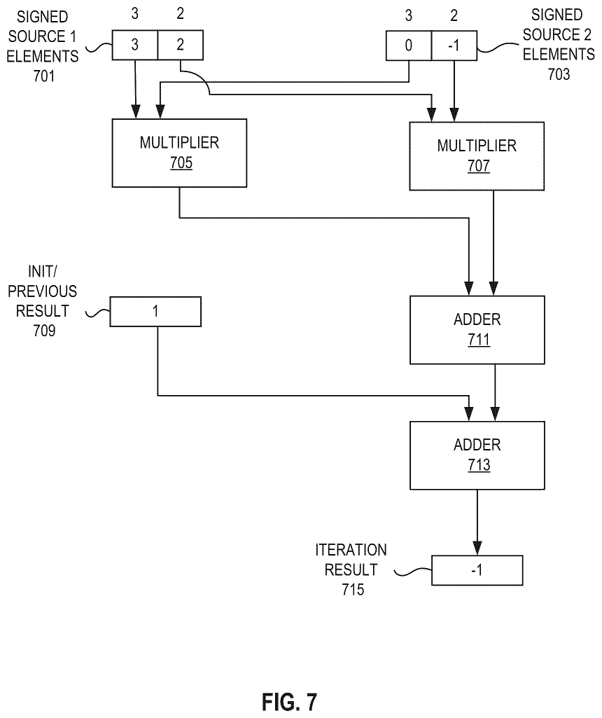

FIG. 7 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on signed sources wherein the accumulator is 2× the input data size.

A first signed source (source 1 701) and a second signed source (source 2 703) each have four packed data elements. Each of these packed data elements stores signed data such as floating-point data. A third signed source (source 3 709) has two packed data elements, each of which stores signed data. The sizes of the first and second signed sources 701 and 703 are half that of the third signed source (initial value or previous result) 709. For example, the first and second signed sources 701 and 703 could have 32-bit packed data elements (e.g., single precision floating-point) while the third signed source 709 could have 64-bit packed data elements (e.g., double precision floating-point).

In this illustration, only the two most significant packed data element positions of the first and second signed sources 701 and 703 and the most significant packed data element position of the third signed source 709 are shown. Of course, the other packed data element positions would also be processed.

As illustrated, packed data elements are processed in pairs. For example, the data of the most significant packed data element positions of the first and second signed sources 701 and 703 are multiplied using a multiplier circuit 705, and the data from second most significant packed data element positions of the first and second signed sources 701 and 703 are multiplied using a multiplier circuit 707. In some embodiments, these multiplier circuits 705 and 707 are reused for other packed data elements positions. In other embodiments, additional multiplier circuits are used so that the packed data elements are processed in parallel. In some contexts, parallel execution is done using lanes that are the size of the signed third source 709. The results of each of the multiplications are added using addition circuitry 711.

The result of the addition of the results of the multiplications is added to the data from most significant packed data element position of the signed source 3 709 (using a different adder 713 or the same adder 711).

Finally, the result of the second addition is either stored into the signed destination 715 in a packed data element position that corresponds to the packed data element position used from the signed third source 709 or passed on to the next iteration if there is one. In some embodiments, a writemask is applied to this storage such that if a corresponding writemask (bit) is set, the storage happens, and, if not set, the storage does not happen.

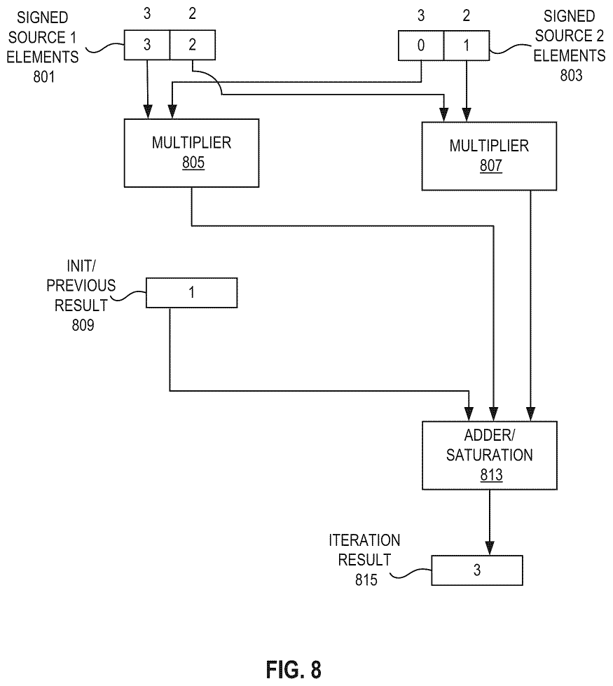

FIG. 8 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on signed sources wherein the accumulator is 2× the input data size.

A first signed source (source 1 801) and a second signed source (source 2 803) each have four packed data elements. Each of these packed data elements stores signed data such as integer data. A third signed source (source 3 809) has two packed data elements, each of which stores signed data. The sizes of the first and second signed sources 801 and 803 are half that of the third signed source 809. For example, the first and second signed sources 801 and 803 could have 32-bit packed data elements (e.g., single precision floating-point) the third signed source 809 could have 64-bit packed data elements (e.g., double precision floating-point).

In this illustration, only the two most significant packed data element positions of the first and second signed sources 801 and 803 and the most significant packed data element position of the third signed source 809 are shown. Of course, the other packed data element positions would also be processed.

As illustrated, packed data elements are processed in pairs. For example, the data of the most significant packed data element positions of the first and second signed sources 801 and 803 are multiplied using a multiplier circuit 805, and the data from second most significant packed data element positions of the first and second signed sources 801 and 803 are multiplied using a multiplier circuit 807. In some embodiments, multiplier circuits 805 and 807 perform the multiplications with infinite precision without saturation and use adder/saturation circuitry 813 to saturate the results of the accumulation to plus or minus infinity in case of an overflow and to zero in case of any underflow. In other embodiments, multiplier circuits 805 and 807 perform the saturation themselves. In some embodiments, these multiplier circuits 805 and 807 are reused for other packed data element positions. In other embodiments, additional multiplier circuits are used so that the packed data elements are processed in parallel. In some contexts, parallel execution is done using lanes that are the size of the signed third source (initial value or previous iteration result) 809. The results of each of the multiplications are added to the signed third source 809 using addition/saturation circuitry 813.

Addition/saturation (accumulator) circuitry 813 preserves a sign of an operand when the addition results in a value that is too big. In particular, saturation evaluation occurs on the infinite precision result between the multi-way-add and the write to the destination or next iteration. When the accumulator 813 is floating-point and the input terms are integer, the sum of products and the floating-point accumulator input value are turned into infinite precision values (fixed point numbers of hundreds of bits), the addition of the multiplication results and the third input is performed, and a single rounding to the actual accumulator type is performed.

Unsigned saturation means the output values are limited to a maximum unsigned number for that element width (all 1s). Signed saturation means a value is limited to the be in the range between a minimum negative number and a max positive number for that element width (for bytes for example, the range is from −128 (=−2\hat{ }7) to 127 (=2\hat{ }7−1)).

The result of the addition and saturation check is stored into the signed result 815 in a packed data element position that corresponds to the packed data element position used from the signed third source 809 or passed on to the next iteration if there is one. In some embodiments, a writemask is applied to this storage such that if a corresponding writemask (bit) is set, the storage happens, and, if not set, the storage does not happen.

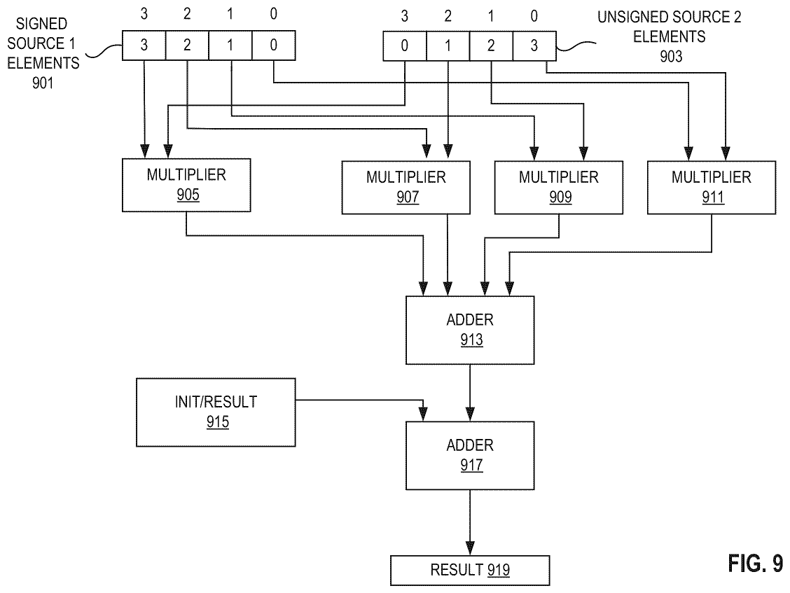

FIG. 9 illustrates an embodiment of a subset of the execution of an iteration of a chained fused multiply accumulate instruction. In particular, this illustrates execution circuitry of an iteration of one packed data element position of the destination. In this embodiment, the chained fused multiply accumulate is operating on a signed source and an unsigned source wherein the accumulator is 4× the input data size.

A first signed source (source 1 901) and a second unsigned source (source 2 903) each have four packed data elements. Each of these packed data elements has data such as floating-point or integer data. A third signed source (initial value or result 915) has a packed data element of which stores signed data. The sizes of the first and second sources 901 and 903 are a quarter of the third signed source 915. For example, the first and second sources 901 and 903 could have 16-bit packed data elements (e.g., word) and the third signed source 915 could have 64-bit packed data elements (e.g., double precision floating-point or 64-bit integer).

In this illustration, the four most significant packed data element positions of the first and second sources 901 and 903 and the most significant packed data element position of the third signed source 915 are shown. Of course, other packed data element positions would also be processed if there are any.

As illustrated, packed data elements are processed in quadruplets. For example, the data of the most significant packed data element positions of the first and second sources 901 and 903 are multiplied using a multiplier circuit 905, data from second most significant packed data element positions of the first and second sources 901 and 903 are multiplied using a multiplier circuit 907, data from third most significant packed data element positions of the first and second sources 901 and 903 are multiplied using a multiplier circuit 909, and data from the least significant packed data element positions of the first and second sources 901 and 903 are multiplied using a multiplier circuit 911. In some embodiments, the signed packed data elements of the first source 901 are sign extended and the unsigned packed data elements of the second source 903 are zero extended prior to the multiplications.

In some embodiments, these multiplier circuits 905-911 are reused for other packed data elements positions. In other embodiments, additional multiplier circuits are used so that the packed data elements are processed in parallel. In some contexts, parallel execution is done using lanes that are the size of the signed third source 915. The results of each of the multiplications are added using addition circuitry 913.

The result of the addition of the results of the multiplications is added to the data from most significant packed data element position of the signed source 3 915 (using a different adder 917 or the same adder 913).

Finally, the result 919 of the second addition is either stored into the signed destination in a packed data element position that corresponds to the packed data element position used from the signed third source 915 or passed to the next iteration. In some embodiments, a writemask is applied to this storage such that if a corresponding writemask (bit) is set, the storage happens, and, if not set, the storage does not happen.

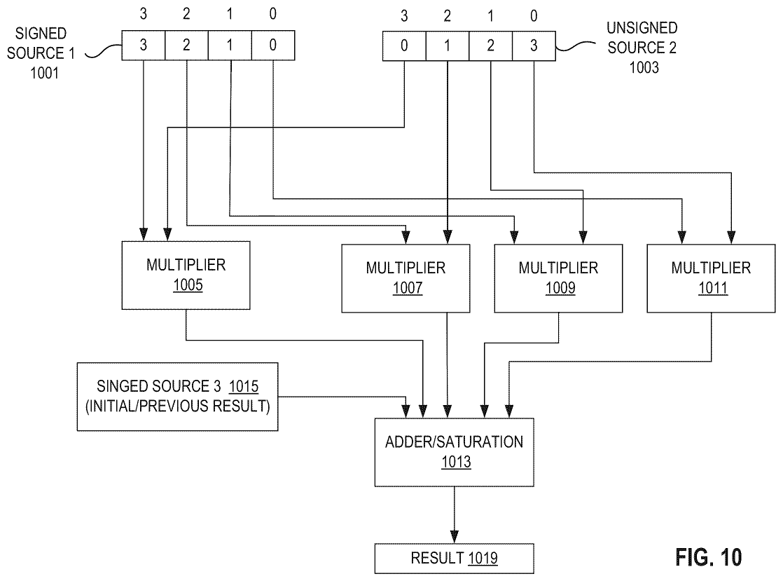

FIG. 10 illustrates an embodiment of a subset of the execution of an iteration of chained fused multiply accumulate instruction. In particular, this illustrates execution circuitry of an iteration of one packed data element position of the destination. In this embodiment, the chained fused multiply accumulate is operating on a signed source and an unsigned source wherein the accumulator is 4× the input data size.

A first signed source 1001 and a second unsigned source 1003 each have four packed data elements. Each of these packed data elements stores data such as floating-point or integer data. A third signed source 1015 (initial or previous result) has a packed data element of which stores signed data. The sizes of the first and second sources are a quarter of the third signed source 1015 (initial or previous result). For example, the first and second sources could have 16-bit packed data elements (e.g., word) and the third signed source 1015 (initial or previous result) could have 64-bit packed data elements (e.g., double precision floating-point or 64-bit integer).

In this illustration, the four most significant packed data element positions of the first signed source 1001 and the second unsigned source 1003 and the most significant packed data element position of the third signed source 1015 are shown. Of course, other packed data element positions would also be processed if there are any.

As illustrated, packed data elements are processed in quadruplets. For example, the data of the most significant packed data element positions of the first signed source 1001 and the second unsigned source 1003 are multiplied using a multiplier circuit 1005, data from second most significant packed data element positions of the first signed source 1001 and the second unsigned source 1003 are multiplied using a multiplier circuit 1007, data from third most significant packed data element positions of the first signed source 1001 and the second unsigned source 1003 are multiplied using a multiplier circuit 1009, and data from the least significant packed data element positions of the first signed source 1001 and the second unsigned source 1003 are multiplied using a multiplier circuit 1011. In some embodiments, the signed packed data elements of the first signed source 1001 are sign extended and the unsigned packed data elements of the second unsigned source 1003 are zero extended prior to the multiplications.

In some embodiments, these multiplier circuits 1005-1011 are reused for other packed data elements positions. In other embodiments, additional multiplier circuits are used so that the packed data elements are processed in parallel. In some contexts, parallel execution is done using lanes that are the size of third signed source 1015 (initial or previous result). The result of the addition of the results of the multiplications is added to the data from most significant packed data element position of third signed source 1015 (initial or previous result) using adder/saturation 1013 circuitry.

Addition/saturation (accumulator) circuitry 1013 preserves a sign of an operand when the addition results in a value that is too big or too small for signed saturation. In particular, saturation evaluation occurs on the infinite precision result between the multi-way-add and the write to the destination. When the accumulator 1013 is floating-point and the input terms are integer, the sum of products and the floating-point accumulator input value are turned into infinite precision values (fixed point numbers of hundreds of bits), the addition of the multiplication results and the third input is performed, and a single rounding to the actual accumulator type is performed.

The result 1019 of the addition and saturation check is stored into the signed destination in a packed data element position that corresponds to the packed data element position used from third signed source 1015 (initial or previous result) or passed to the next iteration. In some embodiments, a writemask is applied to this storage such that if a corresponding writemask (bit) is set, the storage happens, and, if not set, the storage does not happen.

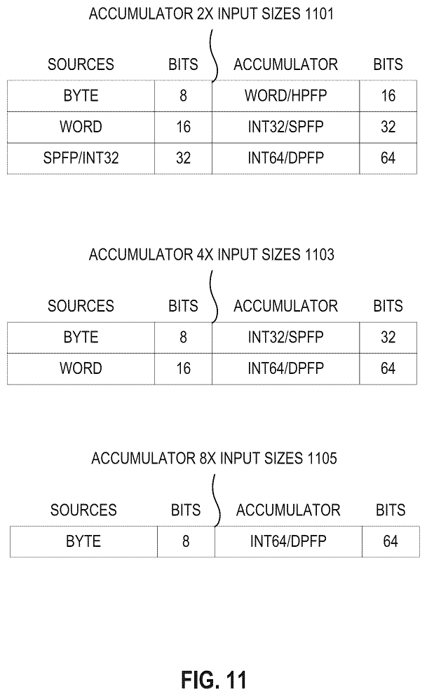

FIG. 11 illustrates power-of-two sized SIMD implementations wherein the accumulators use input sizes that are larger than the inputs to the multipliers according to an embodiment. Note the source (to the multipliers) and accumulator values may be signed or unsigned values. For an accumulator having 2× input sizes (in other words, the accumulator input value is twice the size of the packed data element sizes of the sources), table 1101 illustrates different configurations. For byte sized sources, the accumulator uses word or half-precision floating-point (HPFP) values that are 16-bit in size. For word sized sources, the accumulator uses 32-bit integer or single-precision floating-point (SPFP) values that are 32-bit in size. For SPFP or 32-bit integer sized sources, the accumulator uses 64-integer or double-precision floating-point (DPFP) values that are 64-bit in size.

For an accumulator having 4× input sizes (in other words, the accumulator input value is four times the size of the packed data element sizes of the sources), table 1103 illustrates different configurations. For byte sized sources, the accumulator uses 32-bit integer or single-precision floating-point (SPFP) values that are 32-bit in size. For word sized sources, the accumulator uses 64-bit integer or double-precision floating-point (DPFP) values that are 64-bit in size in some embodiments.

For an accumulator having 8× input sizes (in other words, the accumulator input value is eight times the size of the packed data element sizes of the sources), table 1105 illustrates a configuration. For byte sized sources, the accumulator uses 64-bit integer.

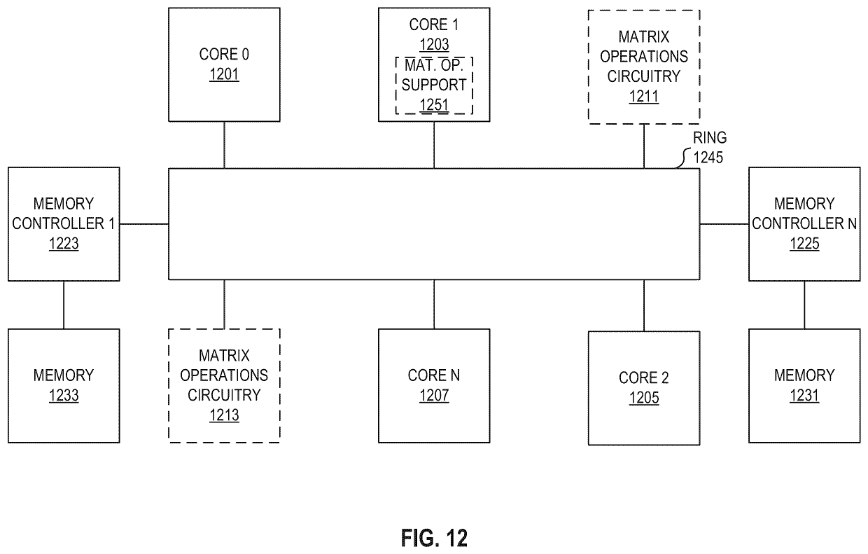

As hinted at earlier, matrix operations circuitry may be included in a core, or as an external accelerator. FIG. 12 illustrates an embodiment of a system utilizing matrix operations circuitry. In this illustration, multiple entities are coupled with a ring interconnect 1245.

A plurality of cores, core 0 1201, core 1 1203, core 2 1205, and core N 1207 provide non-tile-based instruction support. In some embodiments, matrix operations circuitry 1251 is provided in a core 1203, and in other embodiments matrix operations circuitries 1211 and 1213 are accessible on the ring interconnect 1245.

Additionally, one or more memory controllers 1223-1225 are provided to communicate with memory 1233 and 1231 on behalf of the cores and/or matrix operations circuitry.

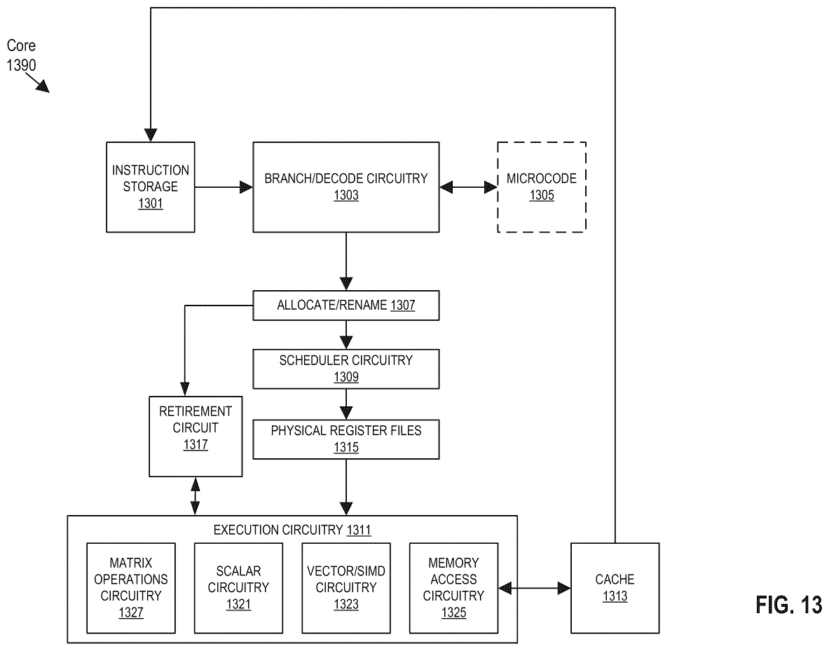

FIG. 13 illustrates an embodiment of a processor core pipeline supporting matrix operations using tiles. Branch prediction and decode circuitry 1303 performs branch predicting of instructions, decoding of instructions, and/or both from instructions stored in instruction storage 1301. For example, instructions detailed herein may be stored in instruction storage. In some implementations, separate circuitry is used for branch prediction and in some embodiments, at least some instructions are decoded into one or more micro-operations, micro-code entry points, microinstructions, other instructions, or other control signals using microcode 1305. The branch prediction and decode circuitry 1303 may be implemented using various mechanisms. Examples of suitable mechanisms include, but are not limited to, look-up tables, hardware implementations, programmable logic arrays (PLAs), microcode read only memories (ROMs), etc.

The branch prediction and decode circuitry 1303 is coupled to allocate/rename 1307 circuitry which is coupled, in some embodiments, to scheduler circuitry 1309. In some embodiments, these circuits provide register renaming, register allocation, and/or scheduling functionality by performing one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

The scheduler circuitry 1309 represents any number of different schedulers, including reservations stations, central instruction window, etc. The scheduler circuitry 1309 is coupled to or includes physical register file(s) 1315. Each of the physical register file(s) 1315 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), tiles, etc. In one embodiment, the physical register file(s) 1315 comprises vector registers circuitry, write mask registers circuitry, and scalar registers circuitry. These register circuits may provide architectural vector registers, vector mask registers, and general-purpose registers. The physical register file(s) 1315 is overlapped by a retirement circuit 1317 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1317 and the physical register file(s) 1315 are coupled to the execution circuitry 1311.

While register renaming is described in the context of out-of-order execution, it should be understood that register renaming may be used in an in-order architecture. While the illustrated embodiment of the processor may also include separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all the cache may be external to the core and/or the processor.

The execution circuitry 1311 is a set of one or more execution circuits, including scalar circuitry 1321, vector/SIMD circuitry 1323, and matrix operations circuitry 1327, as well as memory access circuitry 1325 to access cache 1313. The execution circuits perform various operations (e.g., shifts, addition, subtraction, multiplication) and on various types of data (e.g., scalar floating-point, packed integer, packed floating-point, vector integer, vector floating-point). While some embodiments may include a number of execution units dedicated to specific functions or sets of functions, other embodiments may include only one execution unit or multiple execution units that all perform all functions. The scalar circuitry 1321 performs scalar operations, the vector/SIMD circuitry 1323 performs vector/SIMD operations, and matrix operations circuitry 1327 performs matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1303 performs a decode stage; 3) the allocate/rename 1307 circuitry performs an allocation stage and renaming stage; 4) the scheduler circuitry 1309 performs a schedule stage; 5) physical register file(s) (coupled to, or included in, the scheduler circuitry 1309 and allocate/rename 1307 circuitry and a memory unit perform a register read/memory read stage; the execution circuitry 1311 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

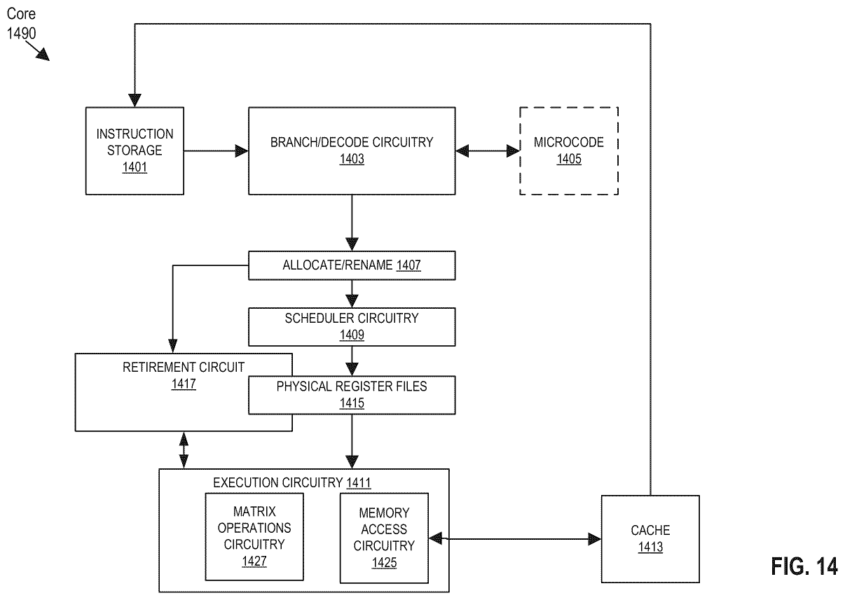

FIG. 14 illustrates an embodiment of a processor core pipeline supporting matrix operations using tiles. Branch prediction and decode circuitry 1403 performs branch predicting of instructions, decoding of instructions, and/or both from instructions stored in instruction storage 1401. For example, instructions detailed herein may be stored in instruction storage. In some implementations, separate circuitry is used for branch prediction and in some embodiments, at least some instructions are decoded into one or more micro-operations, micro-code entry points, microinstructions, other instructions, or other control signals using microcode 1405. The branch prediction and decode circuitry 1403 may be implemented using various mechanisms. Examples of suitable mechanisms include, but are not limited to, look-up tables, hardware implementations, programmable logic arrays (PLAs), microcode read only memories (ROMs), etc.

The branch prediction and decode circuitry 1403 is coupled to allocate/rename 1407 circuitry which is coupled, in some embodiments, to scheduler circuitry 1409. In some embodiments, these circuits provide register renaming, register allocation, and/or scheduling functionality by performing one or more of: 1) renaming logical operand values to physical operand values (e.g., a register alias table in some embodiments), 2) allocating status bits and flags to the decoded instruction, and 3) scheduling the decoded instruction for execution on execution circuitry out of an instruction pool (e.g., using a reservation station in some embodiments).

The scheduler circuitry 1409 represents any number of different schedulers, including reservations stations, central instruction window, etc. The scheduler unit(s) scheduler circuitry 1409 is coupled to or includes physical register file(s) 1415. Each of the physical register file(s) 1415 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), tiles, etc. In one embodiment, the physical register file(s) 1415 comprises vector registers circuitry, write mask registers circuitry, and scalar registers circuitry. These register circuits may provide architectural vector registers, vector mask registers, and general-purpose registers. The physical register file(s) 1415 is overlapped by a retirement circuit 1417 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement circuit 1417 and the physical register file(s) 1415 are coupled to the execution circuitry 1411.

While register renaming is described in the context of out-of-order execution, register renaming may be used in an in-order architecture. While the illustrated embodiment of the processor may also include separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all the cache may be external to the core and/or the processor.

The execution circuitry 1411 a set of one or more execution circuits 1427 and a set of one or more memory access circuits 1425 to access cache 1413. The execution circuits 1427 perform matrix (tile) operations detailed herein.

By way of example, the exemplary register renaming, out-of-order issue/execution core architecture may implement a pipeline as follows: 1) an instruction fetch circuit performs fetch and length decoding stages; 2) the branch and decode circuitry 1403 performs a decode stage; 3) the allocate/rename 1407 circuitry performs an allocation stage and renaming stage; 4) the scheduler circuitry 1409 performs a schedule stage; 5) physical register file(s) (coupled to, or included in, the scheduler circuitry 1409 and allocate/rename 1407 circuitry and a memory unit perform a register read/memory read stage; the execution circuitry 1411 performs an execute stage; 6) a memory unit and the physical register file(s) unit(s) perform a write back/memory write stage; 7) various units may be involved in the exception handling stage; and 8) a retirement unit and the physical register file(s) unit(s) perform a commit stage.

The core may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

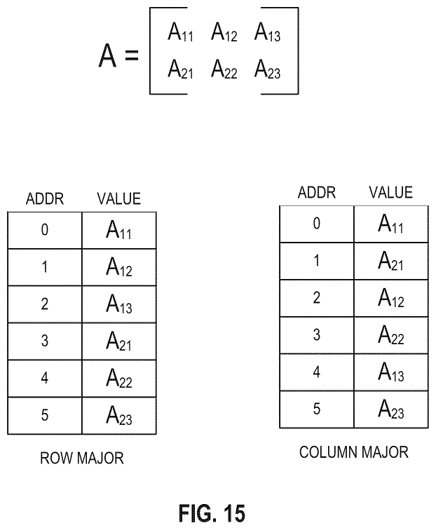

Throughout this description, data is expressed using row major data layout. Column major users should translate the terms according to their orientation. FIG. 15 illustrates an example of a matrix expressed in row major format and column major format. As shown, matrix A is a 2×3 matrix. When this matrix is stored in row major format, the data elements of a row are consecutive. When this matrix is stored in column major format, the data elements of a column are consecutive. It is a well-known property of matrices that AT*BT=(BA) T, where superscript T means transform. Reading column major data as row major data results in the matrix looking like the transform matrix.

In some embodiments, row-major semantics are utilized in hardware, and column major data is to swap the operand order with the result being transforms of matrix, but for subsequent column-major reads from memory it is the correct, non-transformed matrix.

For example, if there are two column-major matrices to multiply:

| a b | g i k | ag + bh ai + bj ak + bl |
|---|---|---|
| c d * | h j l = | cg + dh ci + dj ck + dl |
| e f | | eg + fh ei + fj ek + fl |
| (3 × 2) | (2 × 3) | (3 × 3) |

The input matrices would be stored in linear memory (column-major) as:
a c e b d f
and
g h i j k l.

Reading those matrices as row-major with dimensions 2×3 and 3×2, they would appear as:

| | | |
|---|---|---|
| a c e | and | g h |
| b d f | | i j |
| k l | | |

Swapping the order and matrix multiplying:

| | | |
|---|---|---|
| g h | a c e | ag + bh cg + dh eg + fh |
| i j | * b d f = | ai + bj ci + dj ei + fj |
| k l | | ak + bl ck + dl ek + fl |

The transform matrix is out and can then be stored in in row-major order:

$$ag + bh cg + dh eg + fh ai + bj ci + dj ei + fj ak + bl ck + dl ek + fl$$

and used in subsequent column major computations, it is the correct un-transformed matrix:

| | | |
|---|---|---|
| ag + bh | ai + bj | ak + bl |
| cg + dh | ci + dj | ck + dl |
| eg + fh | ei + fj | ek + fl |

### Exemplary Usage

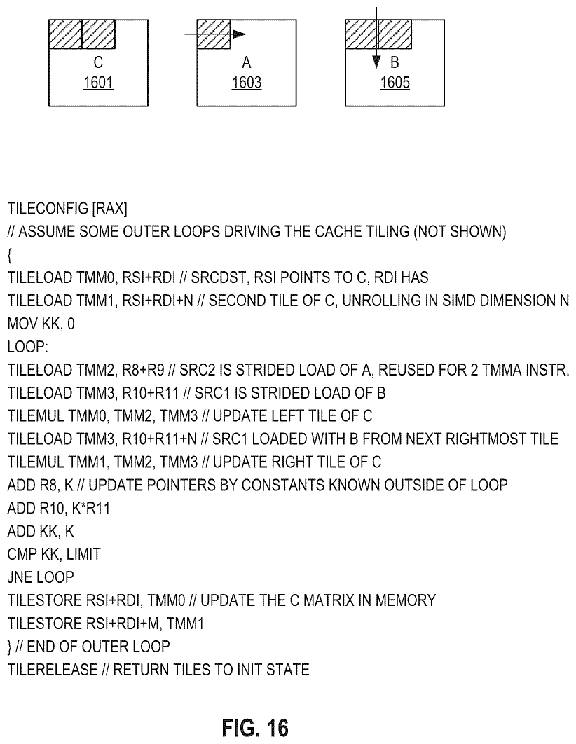

FIG. 16 illustrates an example of usage of matrices (tiles). In this example, matrix C 1601 includes two tiles, matrix A 1603 includes one tile, and matrix B 1605 includes two tiles. This figure shows an example of the inner loop of an algorithm to compute a matrix multiplication. In this example, two result tiles, tmm0 and tmm1, from matrix C 1601 are used to accumulate the intermediate results. One tile from the matrix A 1603 (tmm2) is re-used twice as it multiplied by two tiles from matrix B 1605. Pointers to load a new A matrix (tile) and two new B matrices (tiles) from the directions indicated by the arrows. An outer loop, not shown, adjusts the pointers for the C tiles.

The exemplary code as shown includes the usage of a tile configuration instruction and is executed to configure tile usage, load tiles, a loop to process the tiles, store tiles to memory, and release tile usage.

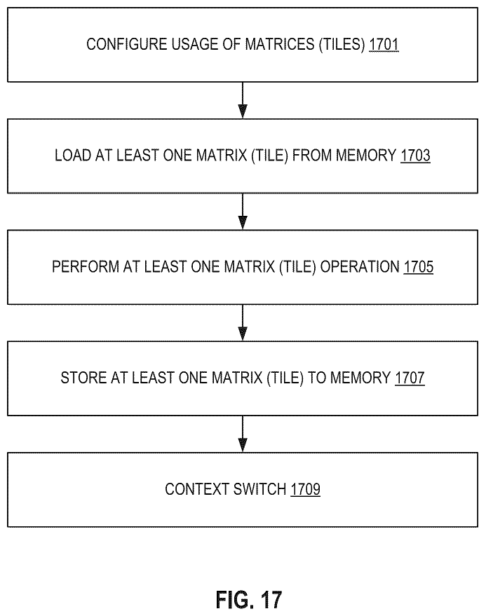

FIG. 17 illustrates an embodiment of usage of matrices (tiles). At block 1701, tile usage is configured. For example, a TILECONFIG instruction is executed to configure tile usage including setting a number of rows and columns per tile. Typically, at least one matrix (tile) is loaded from memory at block 1703. At least one matrix (tile) operation is performed at block 1705 using the matrices (tiles). At block 1707, at least one matrix (tile) is stored out to memory and a context switch can occur at block 1709.

### Exemplary Configuration

### Tile Configuration Hardware Support

As discussed above, tile usage typically needs to be configured prior to use. For example, full usage of all rows and columns may not be needed. Not only does not configuring these rows and columns save power in some embodiments, but the configuration may be used to determine if an operation will generate an error. For example, a matrix multiplication of the form (N×M)*(L×N) will typically not work if M and L are not the same.

Prior to using matrices using tiles, in some embodiments, tile support is to be configured. For example, how many rows and columns per tile, tiles that are to be used, etc. are configured. A TILECONFIG instruction is an improvement to a computer itself as it provides for support to configure the computer to use a matrix accelerator (either as a part of a processor core, or as an external device). In particular, an execution of the TILECONFIG instruction causes a configuration to be retrieved from memory and applied to matrix (tile) settings within a matrix accelerator.

### Tile Usage Configuration

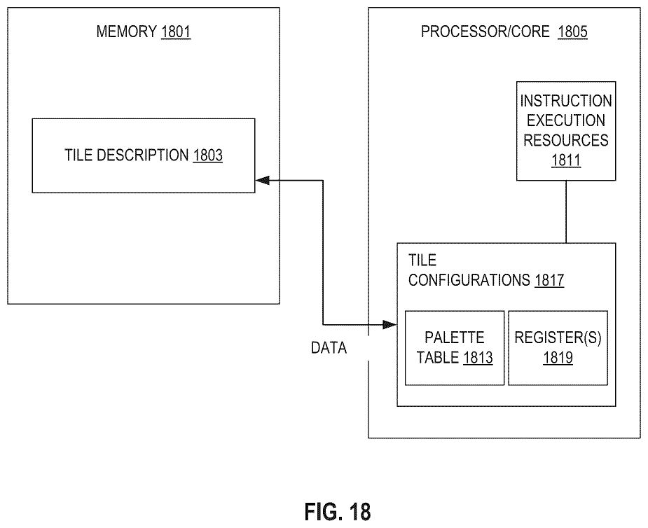

FIG. 18 illustrates support for configuration of the usage of tiles according to an embodiment. A memory 1801 contains the tile description 1803 of the matrices (tiles) to be supported.

Instruction execution resources 1811 of a processor/core 1805 stores aspects of a tile description 1803 into tile configurations 1817. The tile configurations 1817 include palette table 1813 to detail what tiles for a palette are configured (the number of rows and columns in each tile) and a marking that matrix support is in use. In particular, instruction execution resources 1811 are configured to use tiles as specified by the tile configurations 1817. The instruction execution resources 1811 may also include a machine specific register or configuration register to indicate tile usage. Additional values such as in-use and start values are also set. The tile configurations 1817 utilize register(s) 1819 to store tile usage and configuration information.

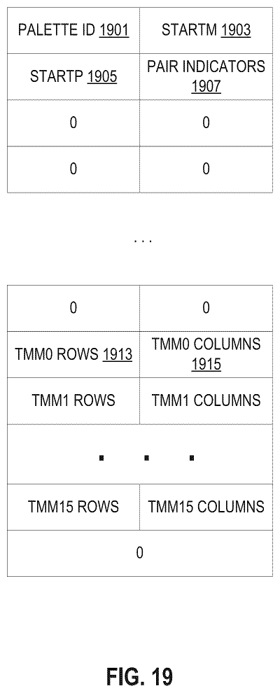

FIG. 19 illustrates an embodiment of a description of the matrices (tiles) to be supported. This is the description that is to be stored upon an execution of a STTILECFG instruction. In this example, each field is a byte. In byte [0], a palette ID 1901 is stored. The palette ID is used to index a palette table 1813 which stores, per palette ID, a number of bytes in a tile, and bytes per row of the tiles that are associated with this ID as defined by the configuration.

Byte 1 stores a value to be stored in a “startRow” register 1903 and byte 2 stores a value to be stored in a register, startP 1905. To support restarting instructions after these events, the instructions store information in these registers. To support restarting instructions after break events such as those detailed above, the instructions store information in these registers. The startRow value indicates the row that should be used for restart. The startP value indicates the position within the row for store operations when pairs are used and, in some embodiments, indicates the lower half of the row (in the lower tile of a pair) or higher half of the row (in the higher tile of a pair). Generally, the position in the row (the column) is not needed.

With the exception of TILECONFIG and STTILECFG, successfully executing matrix (tile) instructions will set both startRow and startP to zero.

Any time an interrupted matrix (tile) instruction is not restarted, it is the responsibility of software to zero the startRow and startP values. For example, unmasked floating-point exception handlers might decide to finish the operation in software and change the program counter value to another instruction, usually the next instruction. In this case the software exception handler must zero the startRow and startP values in the exception presented to it by the operating system before resuming the program. The operating system will subsequently reload those values using a restore instruction.

Byte 3 stores an indication of pairs (lb per tile) of tiles 1907.

Bytes 16-17 store the number of rows 1913 and columns 1915 for tile 0, bytes 18-19 store the number of rows and columns for tile 1, etc. In other words, each 2-byte group specifics a number of rows and columns for a tile. If a group of 2 bytes is not used to specify tile parameters, they should have the value zero. Specifying tile parameters for more tiles than the implementation limit or the palette limit results in a fault. Unconfigured tiles are set to an initial state with 0 rows, 0 columns.

Finally, the configuration in memory typically ends with an ending delineation such as all zeros for several consecutive bytes.

### Exemplary Tile and Tile Configuration Storage

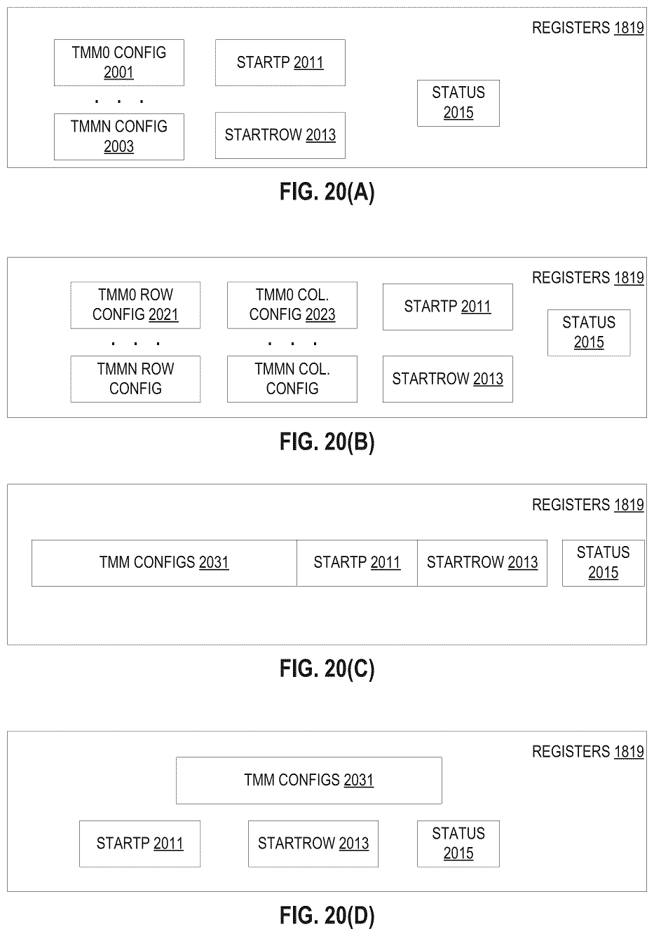

FIGS. 20(A)-(D) illustrate examples of register(s) 1819. FIG. 20(A) illustrates a plurality of registers 1819. As shown each tile (TMM0 2001 . . . . TMMN 2003) has a separate register with each register storing a row and column size for that particular tile. StartP 2011 and StartRow 2013 are stored in separate registers. One or more status registers 2015 are set (e.g., TILES_CONFIGURED=1) to indicate tiles are configured for use.

FIG. 20(B) illustrates a plurality of registers 1819. As shown each tile has separate registers for its rows and columns. For example, TMM0 rows configuration 2021, TMM0 columns configuration 2023, StartP 2011 and StartRow 2013 are stored in separate registers. One or more status registers 2015 are set (e.g., TILES_CONFIGURED=1) to indicate tiles are configured for use.

FIG. 20(C) illustrates a single register 1819. As shown, this register stores tile configurations (rows and columns per tile) 2031, StartP 2011, and StartRow 2013 are stored in single register as packed data registers. One or more status registers 2015 are set (e.g., TILES_CONFIGURED=1) to indicate tiles are configured for use.

FIG. 20(D) illustrates a plurality of registers 1819. As shown, a single register stores tile configuration (rows and columns per tile) 2031. StartP and StartRow are stored in separate registers 2011 and 2013. One or more status registers 2015 are set (e.g., TILECONFIGURED=1) to indicate tiles are configured for use. Other combinations are contemplated such as combining the start registers into a single register where they are shown separately, etc.

Recently various small-exponent floating-point formats have been developed. As used herein, the term “small-exponent floating-point” means floating-point data or formats that have no more than six exponent bits. In some embodiments the “small-exponent floating-point” data or forms may have no more than five exponent bits, no more than four exponent bits, or even less. Examples of such small-exponent floating-point formats having no more than six exponent bits include, but are not limited to, BF8 (E5M2) having five exponent bits and two mantissa bits, HF8 (E4M3) having four exponent bits and three mantissa bits, FP6_E3M2 having three exponent bits and two mantissa bits, FP6_E2M3 having two exponent bits and three mantissa bits, FP4_E2M1 having two exponent bits and one mantissa bits, FP4_E3M0 having three exponent bits and zero mantissa bits, and combinations thereof (e.g., mixed formats and/or mixed precisions). These formats have been developed recently and it is possible that still other formats will be developed.

These small-exponent floating-point formats are widely used in machine learning, artificial intelligence, and various other applications. One reason for using these small-exponent floating-point formats is because they have relatively few bits. This allows a relatively large number of data elements having these formats to be loaded from memory concurrently, stored in the same register, matrix storage, or other storage location, processed concurrently, and stored back to memory concurrently. By way of example, it is common in machine learning and artificial intelligence to perform matrix multiplication (with optional accumulation) on large matrices of data elements with these formats. Without limitation, there may be many hundreds to many thousands of concurrent multiplications and additions. These small-exponent floating-point formats have less range than larger-exponent floating-point formats, but the range is sufficient for certain applications, such as, for example, machine learning, artificial intelligence, and other applications.

Because it is common to process many data elements with such formats concurrently and/or in parallel, it is common for various different types of processors (e.g., general-purpose processors, graphics processing units (GPUs), artificial intelligence processors, machine learning processors, matrix accelerators, etc.) to have a significant amount of replicated circuitry to process these data elements (e.g., large one-dimensional arrays, two-dimensional arrays, grids, or matrices of circuits (e.g., multiplication and accumulation circuits)) to process these data elements concurrently and/or in parallel. As such, it would be advantageous if the circuitry that is replicated was relatively small and/or consumed a relatively small amount of power. However, conventionally, floating-point adders or accumulators tend to be relatively large and/or to consume a relatively large amount of power. This is due in part to the exponent difference circuitry conventionally used to perform exponent difference calculations for addition of floating-point numbers with respect to mantissa accumulation. This is also due in part to needing to handle the data in floating-point format during the addition or accumulation (e.g., to perform rounding, other floating-point complexities, etc.). Accordingly, conventionally the circuitry (e.g., replicated circuitry) to multiply and accumulate small-exponent floating-point data tends to contribute significantly to the overall area, power consumption, and manufacturing cost of the processor. It would be advantageous to be able to make the circuitry used to multiply and accumulate small-exponent floating-point data smaller and/or less power consuming.

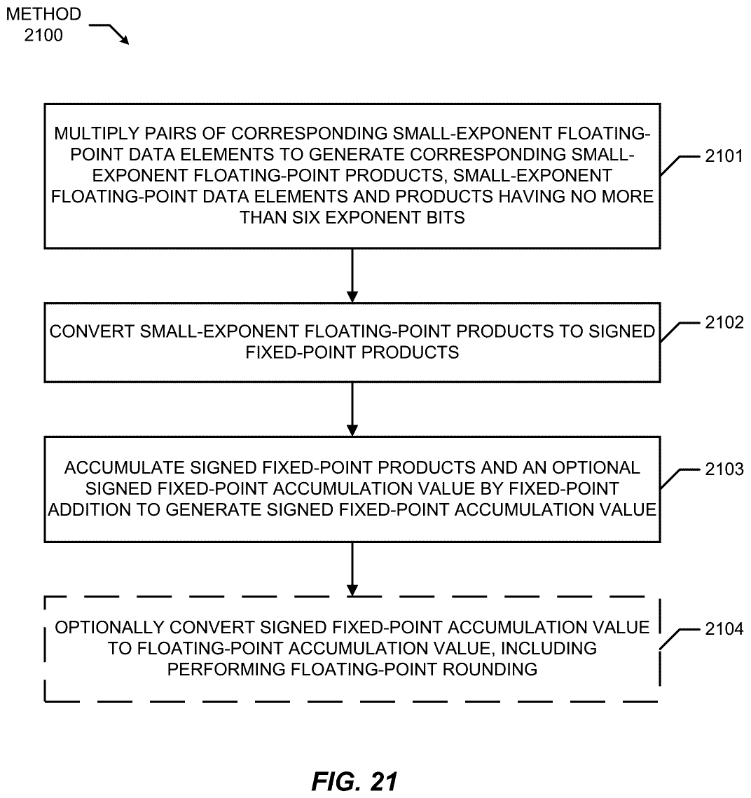

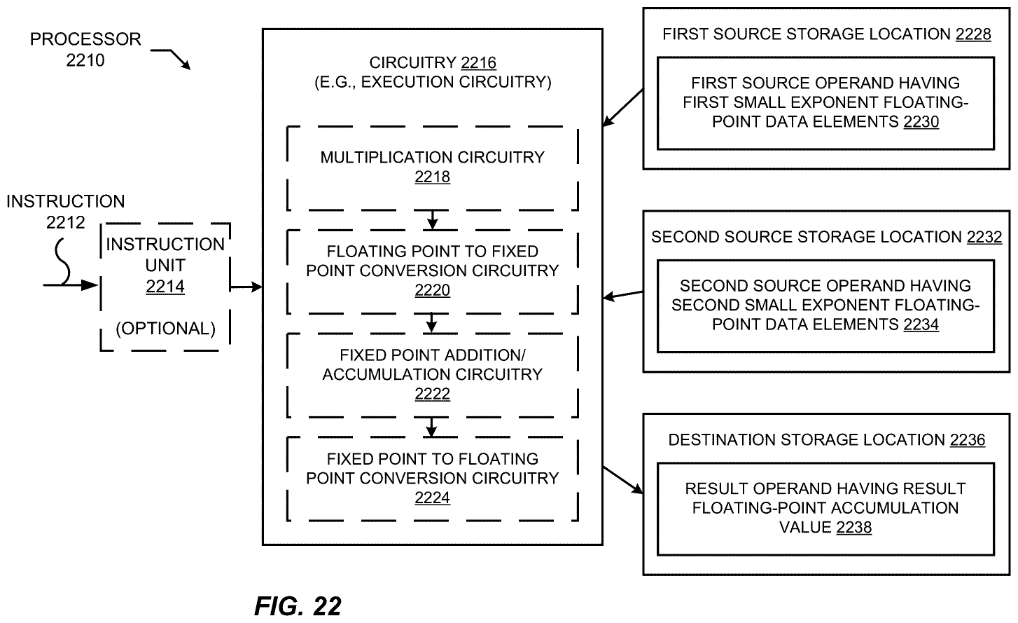

FIG. 21 is a block flow diagram of an embodiment of a method 2100 of multiplying and adding small-exponent floating-point format data elements. In various embodiments, the method may be performed by a processor, integrated circuit, or the like (e.g., in some embodiments the processor 2210 of FIG. 22). In some embodiments, the method may be performed in response to and/or based on execution of an instruction (e.g., a multiply-add instruction, a dot product instruction, an instruction to calculate a sum of outer products, a matrix multiplication instruction, etc.), although the scope of the invention is not so limited.

At block 2101, corresponding pairs of small-exponent floating-point format data elements may be multiplied to generate corresponding floating-point products. The small-exponent floating-point format data elements may either have the same small-exponent floating-point formats or different small-exponent floating-point formats (e.g., mixed formats and/or mixed precisions). In some embodiments, the corresponding pairs of small-exponent floating-point format data elements may have corresponding data element positions (e.g., same bit positions) in two vectors (or packed data or SIMD operands), vector registers, or other storage locations. In other embodiments, the corresponding pairs of small-exponent floating-point format data elements may have data element positions within matrices or submatrices that correspond according to multiplication (with optional accumulation) of two matrices or submatrices.

At block 2102, the floating-point products may be converted to signed integer or otherwise to signed fixed-point products. Integers are a special type of fixed-point data used to represent whole numbers whereas fixed point can contain digits after the decimal point. For simplicity of description, the specification will often refer to fixed point, but it is to be understood that the fixed-point data may optionally be integers. Conventionally there is no such conversion of the floating-point products to integer or fixed-point products. For large exponent floating point data elements (e.g., having more than six exponent bits), the relatively large dynamic range would tend to make this inefficient or impractical at least for commercially viable implementations. However, the small-exponent floating-point format data elements have relatively small dynamic range. For example, the dynamic range of BF8 (E5M2) is between about 2\hat{ }15*1.75 to about 2-16 and the dynamic range of HF8 (E4M3) is between about 2\hat{ }8*1.75 to about 2\hat{ }-9. As such, the relatively small dynamic ranges allow the floating-point data elements to be directly converted to signed integer or signed fixed-point values with no loss in accuracy/precision and/or with infinite accuracy/precision. For example, the conversion may at least conceptually be performed according to the formula fp_number=2exp*mantissa, where the mantissa of the floating-point data element (mantissa) is fixed point, and the exponent of the floating-point data element (exp) is the shift-count for the conversion. The shifting may be performed with respect to zero exponent reference values, which as discussed further below may allow the shift circuitry to be implemented with a relatively small amount of circuitry.

At block 2103, the signed integer or signed fixed-point products are accumulated or added by integer or fixed-point addition to generate a signed integer or signed fixed-point accumulation value. Note that the accumulation or addition is performed by integer addition or fixed-point addition instead of by floating-point addition. Conventionally, when performing floating point multiplication and accumulation, floating-point matrix multiplication, and the like, the floating-point products would be added by floating-point addition. However, as discussed above, floating-point adders tend to be relatively large and to consume a relatively large amount of power (e.g., due to exponent difference circuitry, floating-point rounding, other floating-point complexities). Also, this size and power consumption may be multiplied by the replication of the floating-point adders. Advantageously, since the floating-point products have been converted to signed integer or signed fixed-point products, the addition or accumulation may be performed with integer or other fixed-point addition or accumulation circuitry. The integer or other fixed-point addition or accumulation circuitry may be smaller and consume less power than floating-point addition or accumulation circuitry (e.g., since there is no need for exponent difference circuitry to perform exponent difference calculations, no need for circuitry to perform maximum exponent calculations, no need for floating-point rounding circuitry to perform floating-point rounding, etc.). This may help to simplify the design, reduce area, reduce power consumption, and reduce manufacturing costs. In some embodiments, the signed integers and the optional signed integer accumulation value may be accumulated with no loss in accuracy/precision.

The signed integer or signed fixed-point products may be accumulated or added in various different ways in different embodiments to create different signed integer or signed fixed-point accumulation values. For example, two, four, six, eight, sixteen, or some other number of signed integer or signed fixed-point products may be accumulated or added to respectively generate a two-way (e.g., A1*B1+A2*B2), four-way (A1*B1+A2*B2+A3*B3+A4*B4), cight-way, sixteen-way, or other-way signed integer or signed fixed-point dot product or sum of products. As another example, the signed integer or signed fixed-point products may be accumulated or added based on sum of outer products, based on a matrix multiplication, or based on other useful ways of adding or accumulating the signed integer or signed fixed-point products. In still other examples, any such additions or accumulations may also optionally include adding an accumulation value. Specific examples include a two-way dot product with an accumulation value (e.g., A1*B1+A2*B2+C), a four-way dot product with an accumulation value (e.g., A1*B1+A2*B2+A3*B3+A4*B4+C), and so on. When performing matrix multiplication (or matrix multiplication with accumulation), especially with large matrices (e.g., that may be broken up into submatrices or other fragments that are processed separately), various different types of signed integer or signed fixed-point results may be generated that may subsequently be combined to generate the ultimate matrix multiplication (or matrix multiplication with accumulation) results. Accordingly, the scope of the invention is not particularly limited in terms of how many products and/or precisely which products are added to generate the integer or fixed-point accumulation value.

At block 2104, the signed integer or signed fixed-point accumulation value may optionally be converted to a floating-point result. In some embodiments, the conversion of the signed integer or signed fixed-point accumulation value to the floating-point result may include performing floating-point rounding. Commonly, the floating-point accumulation value may have a larger exponent than the small-exponent floating-point format. For example, the floating-point accumulation value may be single-precision floating-point format (FP32) having cight exponent bits and twenty-four mantissa bits, or double-precision floating-point format (FP64) having eleven exponent bits and fifty-three mantissa bits, or BF16 (E8M7) having eight exponent bits and seven mantissa bits. Conventionally, there is no such conversion of a signed integer or fixed-point accumulation value to a floating-point accumulation value, since conventionally the addition or accumulation of the products would yield a floating-point value and there would therefore be no need to perform such a conversion.

FIG. 22 is a block diagram of an embodiment of a processor 2210. In some embodiments, the processor may be a general-purpose processor (e.g., a general-purpose microprocessor or central processing unit (CPU) of the type used in server, workstation, desktop, laptop, smartphone, and other computers). Alternatively, the processor may be a special-purpose processor. Examples of suitable special-purpose processors include, but are not limited to, graphics processing units (GPUs) including general-purpose GPUs (GPGPUs), matrix accelerators or other processors, artificial intelligence accelerators or other processors, machine-learning accelerators or other processors, digital signal processors (DSPs), accelerators, coprocessors, or the like. In some embodiments, the processor may include (e.g., be disposed on) at least one integrated circuit or semiconductor die (e.g., a system-on-chip (SoC) along with other components.

In some embodiments, the processor may receive an instruction 2212 (e.g., a multiply-add instruction, a dot product instruction, a sum of outer products instruction, a matrix multiplication instruction, etc.). The instruction may represent a relatively low-level instruction or control signal, such as, for example, a macroinstruction, machine code instruction, machine-level instruction, binary instruction, instruction of an instruction set of the processor, or other such instruction or control signal. In other embodiments, there may also optionally be a corresponding higher-level instruction or command with the same or similar attributes. For example, the higher-level instruction or command may be part of the programming interface that programmers use to access the instruction 2212. The processor, or a system in which the processor is included, may have a compiler, instruction translator, or another instruction converter to compile, translate, or otherwise convert the higher-level instruction or command into the instruction 2212. The attributes described for the instruction 2212 may also optionally apply to the higher-level instruction or command.

In some embodiments, the instruction may explicitly specify (e.g., through one or more fields or a set of bits), or otherwise indicate (e.g., implicitly indicate) each of a first source storage location 2228 storing a first source operand 2230 having a first plurality of small-exponent floating-point data elements, a second source storage location 2232 storing a second source operand 2234 having a second plurality of small-exponent floating-point data elements, and a destination storage location 2236 where a result operand 2238 having a result floating-point accumulation value is to be stored. As before, the small-exponent floating-point data elements may either have the same format or different formats. Examples of suitable operands include, but are not limited to, vectors, matrices, and combinations thereof. Examples of suitable storage include, but are not limited to, vector registers (e.g., sometimes referred to as packed registers or SIMD registers), matrix or tile storage (e.g., which may optionally be implemented as vector registers or other types of matrix or tile storage), locations in local or system memory, single instruction, multiple threads (SIMT) registers or storage, and combinations thereof.

The processor may optionally include an instruction unit 2214. The instruction unit broadly represents instruction-based control logic of the processor. The type of instruction unit may vary from one type of processor to another. In the case of a CPU or other general-purpose processor, the instruction unit may represent a decode unit to decode the instruction into one or more relatively lower-level instructions or control signals (e.g., one or more microinstructions, micro-operations, micro-code entry points, decoded instructions or control signals, etc.), which reflect, represent, and/or are derived from the instruction 2212. The decode unit may be implemented using various instruction decode mechanisms including, but not limited to, microcode read only memories (ROMs), look-up tables, hardware implementations, programmable logic arrays (PLAs), other mechanisms suitable to implement decode units, and combinations thereof. For other processors (e.g., GPUs, SIMT processors, etc.), the instruction unit may include one or more of a thread generator unit to initiate threads, an instruction fetch unit to fetch the instruction, a decode unit coupled with the instruction fetch unit to decode the instruction, an instruction scheduler unit coupled with the decode unit to schedule the instructions on one or more threads, and an instruction dispatch unit coupled with the instruction scheduler unit to dispatch the instructions for execution on the one or more threads.

The processor also includes circuitry 2216. In some embodiments, the circuitry may include execution circuitry coupled with the instruction unit to receive one or more lower-level instructions that represent and/or are derived from the instruction 2212 (e.g., one or more decoded instructions, microcode entry points, etc.). The circuitry is also coupled with the first source storage location 2228 to receive the first source operand 2230, is coupled with the second source storage location 2232 to receive the second source operand 2234, and is coupled with the destination storage location 2236 to store the result operand 2238. Examples of suitable types of circuitry and/or execution circuitry and/or execution units include, but are not limited to, vector execution units (e.g., which are sometimes referred to as packed data execution units or SIMD execution units), matrix or tile execution units, one-dimensional arrays of multiply-accumulate circuitry, two-dimensional arrays of multiply-accumulate circuitry, SIMT execution circuitry and/or a SIMT execution unit, to perform the instruction in SIMT fashion, etc. The SIMT execution circuitry or unit may include N processor elements. Examples of suitable processor elements include, but are not limited to, arithmetic and logical units (ALUs), floating-point ALUs, floating-point units, integer units, tensor units, ray tracing cores, texture units, and the like, and various combinations thereof. Certain GPUs available from Nvidia Corporation of Santa Clara, California, United States refer to the SIMT execution unit as a streaming multiprocessor (SM) and refer to the processor elements as either streaming processors (PEs) or cores (e.g., Compute Unified Device Architecture (CUDA) cores). Certain GPUs available from Advanced Micro Devices (AMD), Inc. of Santa Clara, California, United States refer to the SIMT execution unit as a compute unit. For the SIMT execution unit (e.g., a streaming multiprocessor (SM), a compute unit, etc.), each of the PEs may perform instructions of a different corresponding thread of a parallel thread group. These hardware schedulable groups may also be called wavefronts, warps, parallel thread groups, or hardware schedulable groups. By way of example, a wavefront or warp may include 8, 16, 32, 64, or some other number of processor elements each to perform a corresponding thread. Conventionally, these threads or processor elements in the wavefront or warp may perform the same instruction concurrently (e.g., during the same clock cycle).

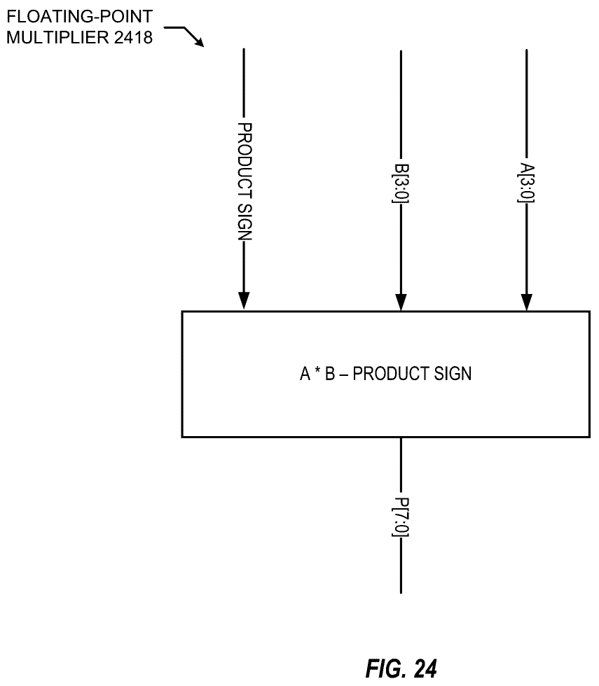

The circuitry (e.g., execution circuitry) 2216 and/or the processor 2210 may execute the instruction 2212 and/or perform operations corresponding to the instruction 2212 and/or otherwise generate and store the result floating-point accumulation value of the result operand 2238. The circuitry 2216 may multiply corresponding pairs of the small-exponent floating-point format data elements from the first source operand 2230 and the second source operand 2234 to generate corresponding floating-point products. The corresponding pairs of data elements may either have corresponding data element positions (e.g., same bit positions) in two vectors (or packed data or SIMD operands), vector registers, or other storage locations or else may have data element positions within matrices or submatrices that correspond according to the multiplication (with optional accumulation) of two matrices or submatrices. As shown, in some embodiments, the circuitry may optionally include floating-point multiplication circuitry 2218 to perform such floating-point multiplications. One specific illustrative example of suitable floating-point multiplication circuitry is the floating-point multiplication circuitry 2418 of FIG. 24, although the scope of the invention is not so limited.

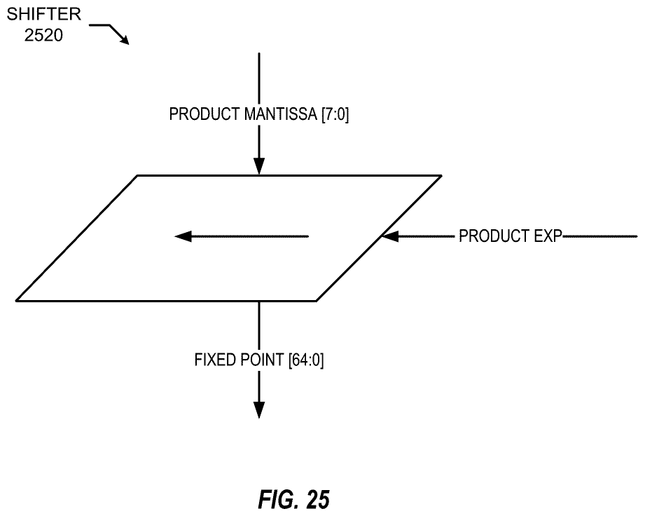

The circuitry 2216 may convert the floating-point products to signed integer or signed fixed-point products. In some embodiments, the conversion may be performed with no loss in accuracy and/or with infinite accuracy, as previously described. As shown, in some embodiments, the circuitry may optionally include floating-point to fixed point (e.g., integer) conversion circuitry 2220 to perform the conversion. One specific illustrative example of suitable floating-point to integer or fixed-point conversion circuitry is the 64-bit alignment shifter 2520 of FIG. 25, although the scope of the invention is not so limited.

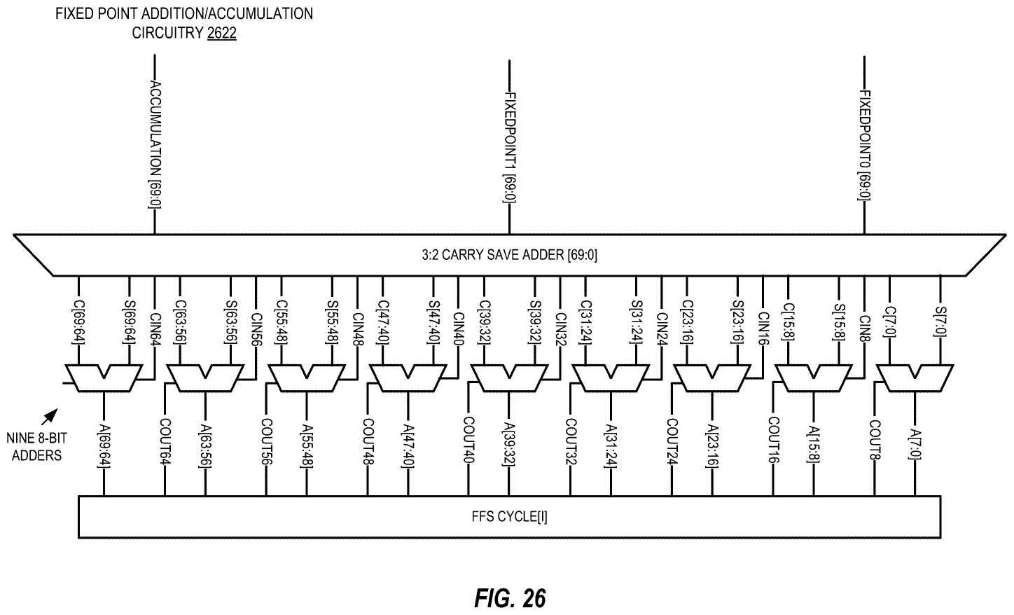

The circuitry 2216 may add or accumulate the signed integer or signed fixed-point products to generate a signed integer or signed fixed-point accumulation value. In some embodiments, the addition or accumulation may be performed by integer addition or fixed-point addition instead of by floating-point addition. In some embodiments, there is no need for exponent difference circuitry to perform exponent difference calculations, no need for floating-point rounding circuitry to perform floating-point rounding, etc. Advantageously, this may potentially help to simplify the design, reduce area, reduce power consumption, and reduce manufacturing costs, as previously described. In various embodiments, various numbers of products may be added or accumulated, with or without an input accumulation value, to generate various dot products, sum of products, sum of outer products, intermediate results of matrix multiplication, final results of matrix multiplication, or other accumulation values, as previously described. As shown, in some embodiments, the circuitry may optionally include integer or other fixed-point addition or accumulation circuitry 2222 (e.g., an integer or fixed-point adder) to add or accumulate the integer or fixed-point products. One specific illustrative example of suitable integer or fixed-point addition circuitry includes the circuitry 2622 of FIG. 26, although the scope of the invention is not so limited.

In some embodiments, the circuitry 2216 may optionally convert the signed integer or signed fixed-point accumulation value to a floating-point accumulation value (e.g., which may be stored in the result operand 2238). In some embodiments, the conversion of the signed integer or signed fixed-point accumulation value to the floating-point accumulation value may include performing floating-point rounding. Commonly, the floating-point accumulation value may have a larger exponent than the small-exponent floating-point format. For example, the floating-point accumulation value may be single-precision floating-point format (FP32) having eight exponent bits and twenty-four mantissa bits, or double-precision floating-point format (FP64) having eleven exponent bits and fifty-three mantissa bits, or BF16 (E8M7) having eight exponent bits and seven mantissa bits. As shown, in some embodiments, the circuitry may optionally include integer or other fixed-point addition or accumulation circuitry 2222 (e.g., an integer or fixed-point adder) to add or accumulate the integer or fixed-point products.

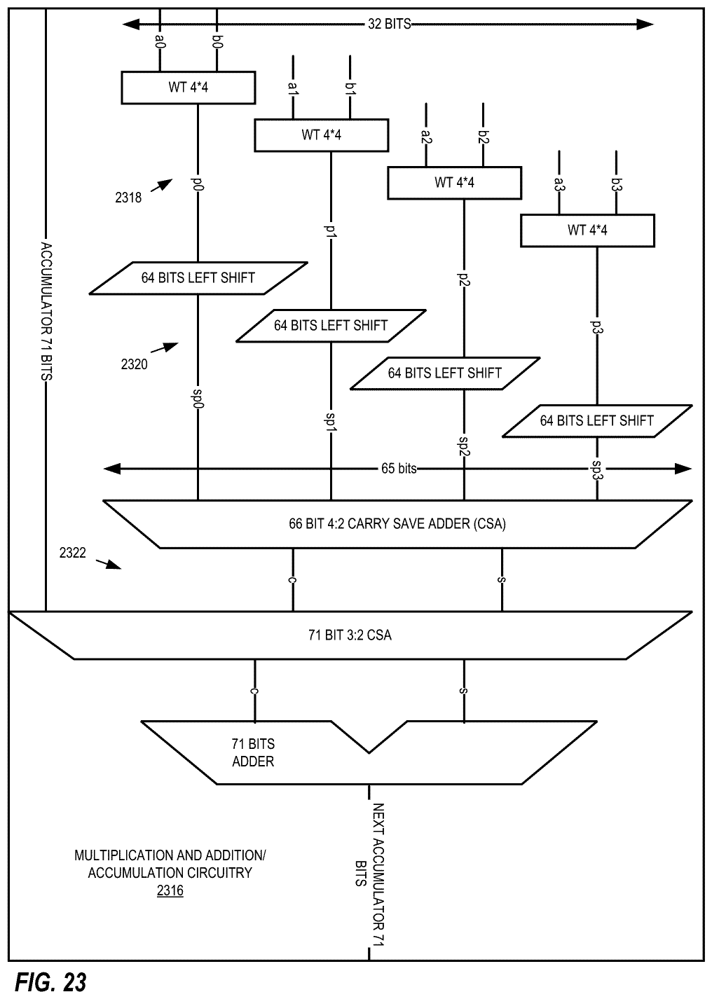

FIG. 23 is a block diagram of an example embodiment of multiplication and addition/accumulation circuitry 2316 to multiply and add/accumulate four pairs of FP8 (e.g., BF8, HF8, or BF8 and HF8) floating-point data elements. In some embodiments, the circuitry 2316 may optionally be replicated to multiply and accumulate more small-exponent floating-point data elements concurrently. For example, there may be an N×M grid of such circuitry where N and M arc 2, 4, 8, 16, 32, 64, etc.

The circuitry includes multiplication circuitry 2318 to multiply the four pairs of small-exponent floating-point data elements. In the illustrated example embodiment, the multiplication circuitry includes four 4×4 Wallace Tree floating-point multipliers (WT 4×4) each to multiply a different respective one of the four pairs, including a first WT 4×4 to multiply a FP8 data element labeled a0 and a FP8 data element labeled b0 to generate a first floating-point product labeled p0, a second WT 4×4 to multiply a FP8 data element labeled a1 and a FP8 data element labeled b1 to generate a second floating-point product labeled p1, a third WT 4×4 to multiply a FP8 data element labeled a2 and a FP8 data element labeled b2 to generate a third floating-point product labeled p2, and a fourth WT 4×4 to multiply a FP8 data element labeled a3 and a FP8 data element labeled b3 to generate a fourth floating-point product labeled p3. A detailed example embodiment of a suitable WT 4×4 floating-point multiplier is shown in FIG. 24, although the scope of the invention is not so limited.

The circuitry also includes floating-point to integer conversion circuitry 2320 to convert each of the four floating-point products labeled p0-p3 to integer. In the illustrated example embodiment, the conversion circuitry includes four 64-bit left shift circuitry each to convert a different respective one of the four floating-point products to integer, including a first 64-bit left shift circuitry to convert p0 to a first integer labeled sp0, a second 64-bit left shift circuitry to convert p1 to a second integer product labeled sp1, a third 64-bit left shift circuitry to convert p2 to a third integer product labeled sp2, and a fourth 64-bit left shift circuitry to convert p3 to a fourth integer product labeled sp3. A detailed example embodiment of suitable 64 bits left shift circuitry is shown in FIGS. 25-26, although the scope of the invention is not so limited.

The circuitry also includes integer addition and/or accumulation circuitry 2322 to add and/or accumulate the four integer products labeled sp0-sp3 and an input (e.g., 71 bit) accumulation value labeled accumulator to generate an (e.g., 71 bit) integer accumulator labeled next accumulator. In the illustrated example embodiment, the integer addition or accumulation circuitry includes a 66 bit 4:2 carry save adder (CSA), a 71 bit 3:2 CSA, and a 71 bit adder.

FIG. 24 is a block diagram of an example embodiment of a floating-point multiplier 2418. In some embodiments, the floating-point multiplier may optionally be implemented as a 4×4 Wallace Trec (WT 4×4) floating-point multiplier. The floating-point multiplier may multiply two mantissas of two FP8 floating-point data elements. FP8 formats have no more than four mantissa bits so their multiplication may be accomplished with a small multiplier. In the illustration, the mantissas are labeled A[3:0] and B[3:0]. Analogous multipliers may be used for other small-exponent floating-point formats. The multiplier may also receive as an input the product sign. The multiplier may output an 8-bit product of the mantissas labeled P[7:0].

The multiplication of a first source floating-point data element (src1) by a second source floating-point data element (src2) may produce a floating-point product data element (product). That is, product=src1*src2. The src1 data element may have a sign (src1.sign), a mantissa (src1.mant) and an exponent (src1.exp). Similarly, the src2 data element may have a sign (src2.sign), a mantissa (src2.mant) and an exponent (src2.exp). Similarly, the product data element may have a sign (product.sign), a mantissa (product.mant) and an exponent (product.exp). The sign of the product is equal to the sign of src1 exclusive OR′d (XOR'd) with the sign of src2 (e.g., product.sign=src1.sign XOR src2.sign). For example, for src1 and scr2 being FP8 where the sign is in bit 7, product.sign=src1[7] XOR src2[7]. The mantissa of the product (product.mant) is equal to the mantissa of src1 multiplied by the mantissa of src2 (e.g., product.mant=src1.mant*src2.mant). The exponent of the product (product.exp) is equal to the sum of the exponent of src1 and the exponent of src2 (e.g., product.exp=src1.exp+src2.exp).

While working in fixed-point, the 8-bit product mantissa may be represented in two's complement. When the sign of the product is negative (e.g., srel.sign is not equal to src2.sign) instead of two's complement, the product mantissa may be calculated as (product−1). So, instead of calculating “−Product=˜Product+1” we utilize-Product=˜(Product−1)=−(Product−1)−1. Using this technique may allow the two's complement values to be produced efficiently. So, when the sign is positive the product mantissa (prod.mant[7:0] may be calculated as product or when the sign is negative the product mantissa (prod.mant[7:0] may be calculated as ˜ (product−1). The product sign (product.sign) may be calculated as TS & (P.mantissa< >0×00).

Small-exponent floating-point values (e.g., FP8 values) have a relatively small dynamic range. For example, BF8 (E5M2) has five exponent bits and a dynamic range between 2\hat{ }15*1.75 to 2\hat{ }−16, and HF8 (E4M3) has only four exponent bits and a dynamic range between 2\hat{ }8*1.75 to 2\hat{ }−9. For BF8 (E5M2) the smallest denormal value that can be represented is 2\hat{ }-16 and for HF8 (E4M3) the smallest denormal value that can be represented is 2\hat{ }-9. Such small dynamic ranges and smallest denormals allow small-exponent floating-point values to be directly converted to signed integer values, with infinite accuracy/precision and/or no loss of accuracy/precision, where the signed integer values are small enough that they can be contained in a sufficiently small number of bits. Recall that when multiplying floating-point data elements, the product exponent is the sum of the two source exponents (e.g., product.exp==src1.exp+src2.exp). When converting the products to integers the exponent may also be increased by two offsets that consider the smallest denormal values of the source floating-point values. A first offset (offset1) for the first source multiplicand (src1) may be set equal to 16 if src1 is BF8 or else set equal to 9 if src1 is HF8. Similarly, a second offset (offset2) for the second source multiplicand (src2) may be set equal to 16 if src1 is BF8 or 9 if src1 is HF8. Other offsets may apply for the other small-exponent floating point formats. A shift amount may be calculated that is used to convert the product to an integer as the sum of the first source exponent, the second source exponent, the first offset, and the second offset (e.g., AlignmentShiftCnt[5:0]=src1.exp+src2.exp+offset1+offset2). If the sign of the product is negative then the fixed point integer value may then be calculated according to signed_product_value[64:0]=˜ Product.mant<<AlignmentShiftCnt[5:0]. Conversely, if the sign of the product is positive then the fixed point integer value may then be calculated according to signed_product_value[64:0]=Product.mant<<AlignmentShiftCnt[5:0]. In these expressions, the symbol “<<” represents a left shift.

FIG. 25 is an example embodiment of an alignment shifter 2520. In this example, the alignment shifter is a 64-bit alignment shifter although other sizes may also be used. The shifter may receive as a first input a product mantissa (e.g., an 8 bit product mantissa[7:0]), as a second input a product exponent, and may output a signed fixed-point product (e.g., in this example a signed 65-bit fixed point product[64:0]). In some embodiments, additional bits may optionally be included (e.g., the 65 bits may be sign extended by one or more bits) to allow for multiple values to be accumulated. In one example, the 65 bits may be sign extended to around 70 bits (e.g., labeled as FixedPoint[70:0]) to provide room for accumulating around 32 product values.

FIG. 26 is a block diagram of a detailed example embodiment of integer addition and/or accumulation circuitry 2622. The circuitry 2622 may add a first integer labeled FixedPoint0 [69:0], a second integer labeled FixedPoint1 [69:0], and an input accumulation value labeled Accumulation [69:0] to generate an output accumulation value. Nine 8-bit adders are used in this example. In this example, 70 bit integers are added, although other sizes are also possible. In some embodiments, in order to avoid using a relatively large 71 bit adder, the addition may optionally be broken into 8 bit adders with carry-in and carry-out labeled “8 bit add”. Such an approach may implement the addition faster and more efficiently.

When all products and an optional input accumulation value have been accumulated the resulting accumulation value may optionally be converted back to floating-point format (e.g., single precision floating point, double precision floating point, BF16, etc.) with optional floating-point rounding. As one specific example, the resulting accumulation value may a 71 bit integer value that is converted to single precision floating point (FP32) taking into account the offset1+offset2 as explained above and performing a single floating-point rounding operation.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

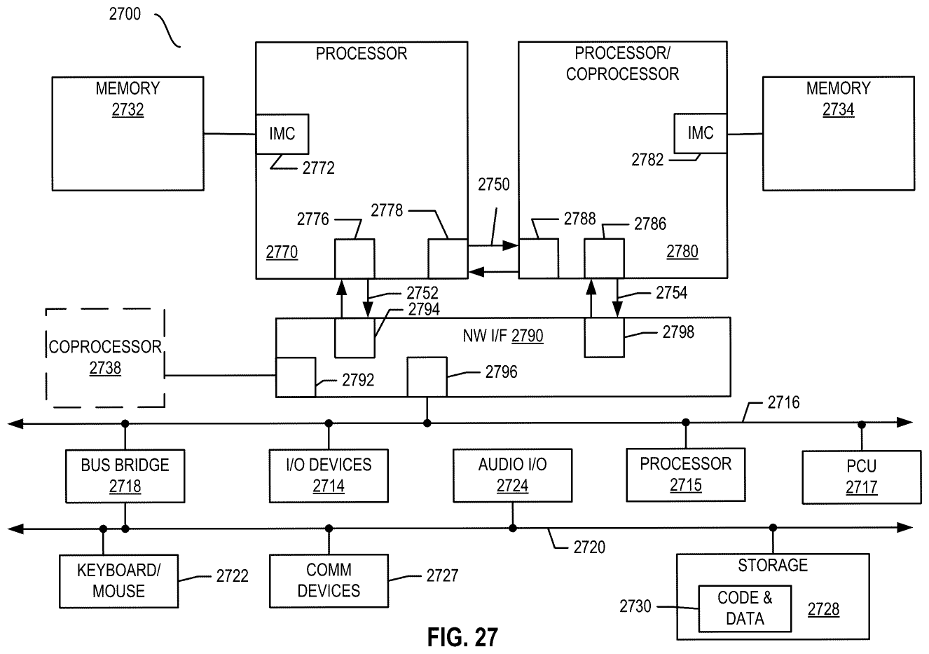

FIG. 27 illustrates an example computing system. Multiprocessor system 2700 is an interfaced system and includes a plurality of processors or cores including a first processor 2770 and a second processor 2780 coupled via an interface 2750 such as a point-to-point (P-P) interconnect, a fabric, and/or bus. In some examples, the first processor 2770 and the second processor 2780 are homogeneous. In some examples, the first processor 2770 and the second processor 2780 are heterogenous. Though the example system 2700 is shown to have two processors, the system may have three or more processors, or may be a single processor system. In some examples, the computing system is a system on a chip (SoC).

Processors 2770 and 2780 are shown including integrated memory controller (IMC) circuitry 2772 and 2782, respectively. Processor 2770 also includes interface circuits 2776 and 2778; similarly, second processor 2780 includes interface circuits 2786 and 2788. Processors 2770, 2780 may exchange information via the interface 2750 using interface circuits 2778, 2788. IMCs 2772 and 2782 couple the processors 2770, 2780 to respective memories, namely a memory 2732 and a memory 2734, which may be portions of main memory locally attached to the respective processors.

Processors 2770, 2780 may each exchange information with a network interface (NW I/F) 2790 via individual interfaces 2752, 2754 using interface circuits 2776, 2794, 2786, 2798. The network interface 2790 (e.g., one or more of an interconnect, bus, and/or fabric, and in some examples is a chipset) may optionally exchange information with a coprocessor 2738 via an interface circuit 2792. In some examples, the coprocessor 2738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 2770, 2780 or outside of both processors, yet connected with the processors via an interface such as P-P interconnect, such that either or both processors' local cache information may be stored in the shared cache if a processor is placed into a low power mode.

Network interface 2790 may be coupled to a first interface 2716 via interface circuit 2796. In some examples, the first interface 2716 may be an interface such as a Peripheral Component Interconnect (PCI) interconnect, a PCI Express interconnect or another I/O interconnect. In some examples, the first interface 2716 is coupled to a power control unit (PCU) 2717, which may include circuitry, software, and/or firmware to perform power management operations regarding the processors 2770, 2780 and/or co-processor 2738. PCU 2717 provides control information to a voltage regulator (not shown) to cause the voltage regulator to generate the appropriate regulated voltage. PCU 2717 also provides control information to control the operating voltage generated. In various examples, PCU 2717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 2717 is illustrated as being present as logic separate from the processor 2770 and/or processor 2780. In other cases, PCU 2717 may execute on a given one or more of cores (not shown) of processor 2770 or 2780. In some cases, PCU 2717 may be implemented as a microcontroller (dedicated or general-purpose) or other control logic configured to execute its own dedicated power management code, sometimes referred to as P-code. In yet other examples, power management operations to be performed by PCU 2717 may be implemented externally to a processor, such as by way of a separate power management integrated circuit (PMIC) or another component external to the processor. In yet other examples, power management operations to be performed by PCU 2717 may be implemented within BIOS or other system software.

Various I/O devices 2714 may be coupled to first interface 2716, along with a bus bridge 2718 which couples first interface 2716 to a second interface 2720. In some examples, one or more additional processor(s) 2715, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 2716. In some examples, the second interface 2720 may be a low pin count (LPC) interface. Various devices may be coupled to second interface 2720 including, for example, a keyboard and/or mouse 2722, communication devices 2727 and storage circuitry 2728. Storage circuitry 2728 may be one or more non-transitory machine-readable storage media as described below, such as a disk drive or other mass storage device which may include instructions/code and data 2730 and may implement the storage ‘ISAB03 in some examples. Further, an audio I/O 2724 may be coupled to second interface 2720. Note that other architectures than the point-to-point architecture described above are possible. For example, instead of the point-to-point architecture, a system such as multiprocessor system 2700 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

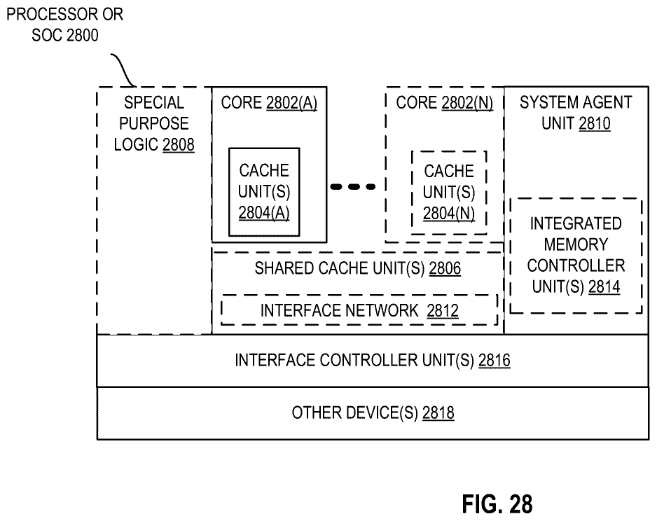

FIG. 28 illustrates a block diagram of an example processor and/or SoC 2800 that may have one or more cores and an integrated memory controller. The solid lined boxes illustrate a processor 2800 with a single core 2802(A), system agent unit circuitry 2810, and a set of one or more interface controller unit(s) circuitry 2816, while the optional addition of the dashed lined boxes illustrates an alternative processor 2800 with multiple cores 2802(A)-(N), a set of one or more integrated memory controller unit(s) circuitry 2814 in the system agent unit circuitry 2810, and special purpose logic 2808, as well as a set of one or more interface controller units circuitry 2816. Note that the processor 2800 may be one of the processors 2770 or 2780, or co-processor 2738 or 2715 of FIG. 27.

Thus, different implementations of the processor 2800 may include: 1) a CPU with the special purpose logic 2808 being integrated graphics and/or scientific (throughput) logic (which may include one or more cores, not shown), and the cores 2802(A)-(N) being one or more general purpose cores (e.g., general purpose in-order cores, general purpose out-of-order cores, or a combination of the two); 2) a coprocessor with the cores 2802(A)-(N) being a large number of special purpose cores intended primarily for graphics and/or scientific (throughput); and 3) a coprocessor with the cores 2802(A)-(N) being a large number of general purpose in-order cores. Thus, the processor 2800 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 2800 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 2804(A)-(N) within the cores 2802(A)-(N), a set of one or more shared cache unit(s) circuitry 2806, and external memory (not shown) coupled to the set of integrated memory controller unit(s) circuitry 2814. The set of one or more shared cache unit(s) circuitry 2806 may include one or more mid-level caches, such as level 2 (L2), level 3 (L3), level 4 (L4), or other levels of cache, such as a last level cache (LLC), and/or combinations thereof. While in some examples interface network circuitry 2812 (e.g., a ring interconnect) interfaces the special purpose logic 2808 (e.g., integrated graphics logic), the set of shared cache unit(s) circuitry 2806, and the system agent unit circuitry 2810, alternative examples use any number of well-known techniques for interfacing such units. In some examples, coherency is maintained between one or more of the shared cache unit(s) circuitry 2806 and cores 2802(A)-(N). In some examples, interface controller unit's circuitry 2816 couple the cores 2802 to one or more other devices 2818 such as one or more I/O devices, storage, one or more communication devices (e.g., wireless networking, wired networking, etc.), etc.

In some examples, one or more of the cores 2802(A)-(N) are capable of multi-threading. The system agent unit circuitry 2810 includes those components coordinating and operating cores 2802(A)-(N). The system agent unit circuitry 2810 may include, for example, power control unit (PCU) circuitry and/or display unit circuitry (not shown). The PCU may be or may include logic and components needed for regulating the power state of the cores 2802(A)-(N) and/or the special purpose logic 2808 (e.g., integrated graphics logic). The display unit circuitry is for driving one or more externally connected displays.

The cores 2802(A)-(N) may be homogenous in terms of instruction set architecture (ISA). Alternatively, the cores 2802(A)-(N) may be heterogeneous in terms of ISA; that is, a subset of the cores 2802(A)-(N) may be capable of executing an ISA, while other cores may be capable of executing only a subset of that ISA or another ISA.

### Example Core Architectures—In-Order and Out-of-Order Core Block Diagram.

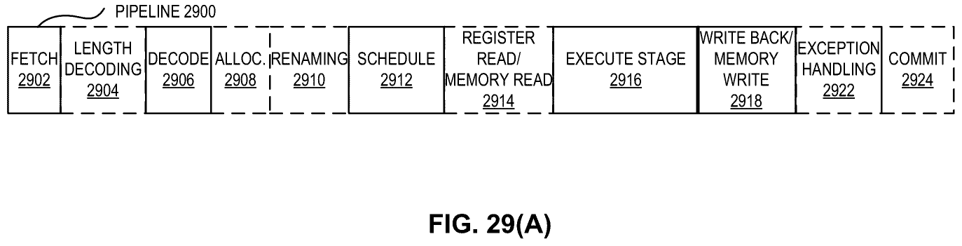

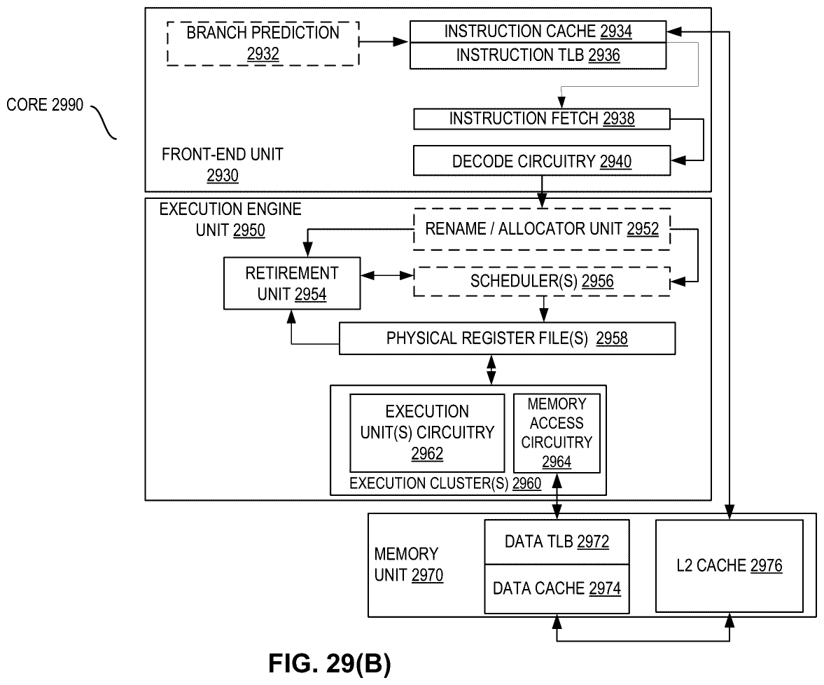

FIG. 29(A) is a block diagram illustrating both an example in-order pipeline and an example register renaming, out-of-order issue/execution pipeline according to examples. FIG. 29(B) is a block diagram illustrating both an example in-order architecture core and an example register renaming, out-of-order issue/execution architecture core to be included in a processor according to examples. The solid lined boxes in FIGS. 29(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 29(A), a processor pipeline 2900 includes a fetch stage 2902, an optional length decoding stage 2904, a decode stage 2906, an optional allocation (Alloc) stage 2908, an optional renaming stage 2910, a schedule (also known as a dispatch or issue) stage 2912, an optional register read/memory read stage 2914, an execute stage 2916, a write back/memory write stage 2918, an optional exception handling stage 2922, and an optional commit stage 2924. One or more operations can be performed in each of these processor pipeline stages. For example, during the fetch stage 2902, one or more instructions are fetched from instruction memory, and during the decode stage 2906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 2906 and the register read/memory read stage 2914 may be combined into one pipeline stage. In one example, during the execute stage 2916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 29(B) may implement the pipeline 2900 as follows: 1) the instruction fetch circuitry 2938 performs the fetch and length decoding stages 2902 and 2904; 2) the decode circuitry 2940 performs the decode stage 2906; 3) the rename/allocator unit circuitry 2952 performs the allocation stage 2908 and renaming stage 2910; 4) the scheduler(s) circuitry 2956 performs the schedule stage 2912; 5) the physical register file(s) circuitry 2958 and the memory unit circuitry 2970 perform the register read/memory read stage 2914; the execution cluster(s) 2960 perform the execute stage 2916; 6) the memory unit circuitry 2970 and the physical register file(s) circuitry 2958 perform the write back/memory write stage 2918; 7) various circuitry may be involved in the exception handling stage 2922; and 8) the retirement unit circuitry 2954 and the physical register file(s) circuitry 2958 perform the commit stage 2924.

FIG. 29(B) shows a processor core 2990 including front-end unit circuitry 2930 coupled to execution engine unit circuitry 2950, and both are coupled to memory unit circuitry 2970. The core 2990 may be a reduced instruction set architecture computing (RISC) core, a complex instruction set architecture computing (CISC) core, a very long instruction word (VLIW) core, or a hybrid or alternative core type. As yet another option, the core 2990 may be a special-purpose core, such as, for example, a network or communication core, compression engine, coprocessor core, general purpose computing graphics processing unit (GPGPU) core, graphics core, or the like.

The front-end unit circuitry 2930 may include branch prediction circuitry 2932 coupled to instruction cache circuitry 2934, which is coupled to an instruction translation lookaside buffer (TLB) 2936, which is coupled to instruction fetch circuitry 2938, which is coupled to decode circuitry 2940. In one example, the instruction cache circuitry 2934 is included in the memory unit circuitry 2970 rather than the front-end circuitry 2930. The decode circuitry 2940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 2940 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 2940 may be implemented using various mechanisms. Examples of suitable mechanisms include, but are not limited to, look-up tables, hardware implementations, programmable logic arrays (PLAs), microcode read only memories (ROMs), ctc. In one example, the core 2990 includes a microcode ROM (not shown) or other medium that stores microcode for certain macroinstructions (e.g., in decode circuitry 2940 or otherwise within the front-end circuitry 2930). In one example, the decode circuitry 2940 includes a micro-operation (micro-op) or operation cache (not shown) to hold/cache decoded operations, micro-tags, or micro-operations generated during the decode or other stages of the processor pipeline 2900. The decode circuitry 2940 may be coupled to rename/allocator unit circuitry 2952 in the execution engine circuitry 2950.

The execution engine circuitry 2950 includes the rename/allocator unit circuitry 2952 coupled to retirement unit circuitry 2954 and a set of one or more scheduler(s) circuitry 2956. The scheduler(s) circuitry 2956 represents any number of different schedulers, including reservations stations, central instruction window, etc. In some examples, the scheduler(s) circuitry 2956 can include arithmetic logic unit (ALU) scheduler/scheduling circuitry, ALU queues, address generation unit (AGU) scheduler/scheduling circuitry, AGU queues, etc. The scheduler(s) circuitry 2956 is coupled to the physical register file(s) circuitry 2958. Each of the physical register file(s) circuitry 2958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 2958 includes vector registers unit circuitry, writemask registers unit circuitry, and scalar register unit circuitry. These register units may provide architectural vector registers, vector mask registers, general-purpose registers, etc. The physical register file(s) circuitry 2958 is coupled to the retirement unit circuitry 2954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 2954 and the physical register file(s) circuitry 2958 are coupled to the execution cluster(s) 2960. The execution cluster(s) 2960 includes a set of one or more execution unit(s) circuitry 2962 and a set of one or more memory access circuitry 2964. The execution unit(s) circuitry 2962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 2956, physical register file(s) circuitry 2958, and execution cluster(s) 2960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 2964). It should also be understood that where separate pipelines are used, one or more of these pipelines may be out-of-order issue/execution and the rest in-order.

In some examples, the execution engine unit circuitry 2950 may perform load store unit (LSU) address/data pipelining to an Advanced Microcontroller Bus (AMB) interface (not shown), and address phase and writeback, data phase load, store, and branches.

The set of memory access circuitry 2964 is coupled to the memory unit circuitry 2970, which includes data TLB circuitry 2972 coupled to data cache circuitry 2974 coupled to level 2 (L2) cache circuitry 2976. In one example, the memory access circuitry 2964 may include load unit circuitry, store address unit circuitry, and store data unit circuitry, each of which is coupled to the data TLB circuitry 2972 in the memory unit circuitry 2970. The instruction cache circuitry 2934 is further coupled to the level 2 (L2) cache circuitry 2976 in the memory unit circuitry 2970. In one example, the instruction cache 2934 and the data cache 2974 are combined into a single instruction and data cache (not shown) in L2 cache circuitry 2976, level 3 (L3) cache circuitry (not shown), and/or main memory. The L2 cache circuitry 2976 is coupled to one or more other levels of cache and eventually to a main memory.

The core 2990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 2990 includes logic to support a packed data instruction set architecture extension (e.g., AVX1, AVX2), thereby allowing the operations used by many multimedia applications to be performed using packed data.

### Example Execution Unit(s) Circuitry.

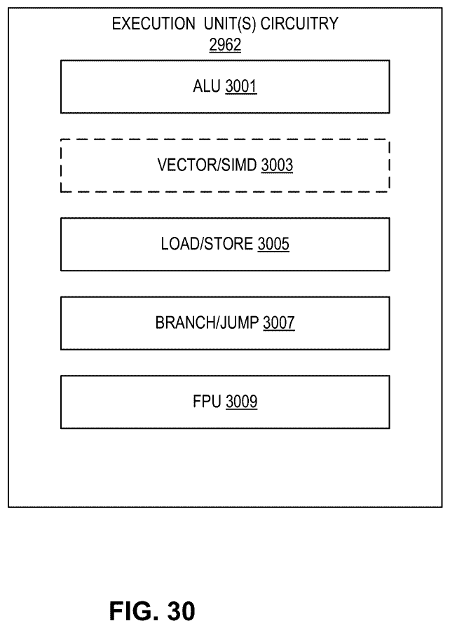

FIG. 30 illustrates examples of execution unit(s) circuitry, such as execution unit(s) circuitry 2962 of FIG. 29(B). As illustrated, execution unit(s) circuitry 2962 may include one or more ALU circuits 3001, optional vector/single instruction multiple data (SIMD) circuits 3003, load/store circuits 3005, branch/jump circuits 3007, and/or Floating-point unit (FPU) circuits 3009. ALU circuits 3001 perform integer arithmetic and/or Boolean operations. Vector/SIMD circuits 3003 perform vector/SIMD operations on packed data (such as SIMD/vector registers). Load/store circuits 3005 execute load and store instructions to load data from memory into registers or store from registers to memory. Load/store circuits 3005 may also generate addresses. Branch/jump circuits 3007 cause a branch or jump to a memory address depending on the instruction. FPU circuits 3009 perform floating-point arithmetic. The width of the execution unit(s) circuitry 2962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

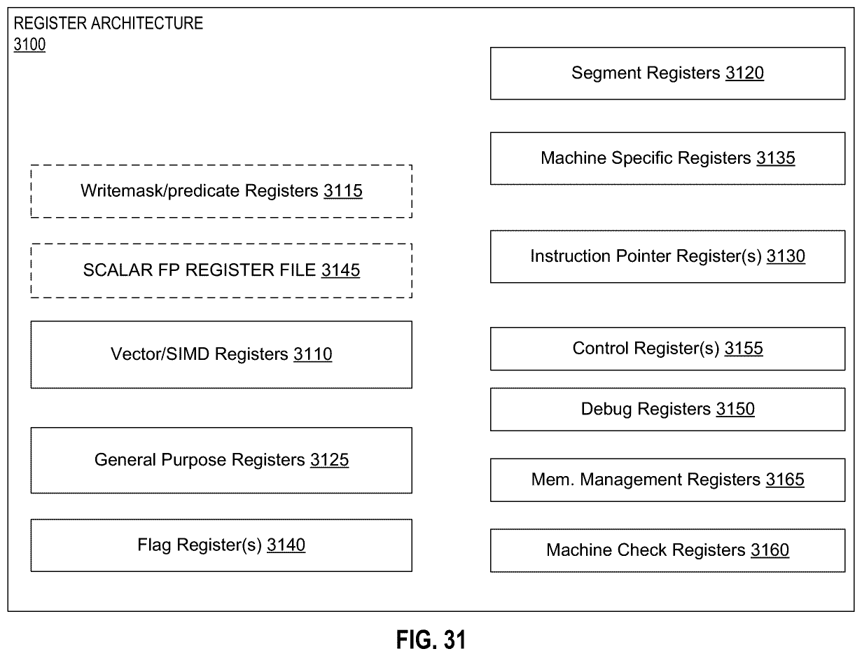

FIG. 31 is a block diagram of a register architecture 3100 according to some examples. As illustrated, the register architecture 3100 includes vector/SIMD registers 3110 that vary from 128-bit to 1,024 bits width. In some examples, the vector/SIMD registers 3110 are physically 512-bits and, depending upon the mapping, only some of the lower bits are used. For example, in some examples, the vector/SIMD registers 3110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 3100 includes writemask/predicate registers 3115. For example, in some examples, there are 8 writemask/predicate registers (sometimes called k0 through k7) that are each 16-bit, 32-bit, 64-bit, or 128-bit in size. Writemask/predicate registers 3115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 3115 corresponds to a data element position of the destination. In other examples, the writemask/predicate registers 3115 are scalable and consists of a set number of enable bits for a given vector element (e.g., 8 enable bits per 64-bit vector element).

The register architecture 3100 includes a plurality of general-purpose registers 3125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 3100 includes scalar floating-point (FP) register file 3145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 3140 (e.g., EFLAGS, RFLAGS, etc.) store status and control information for arithmetic, compare, and system operations. For example, the one or more flag registers 3140 may store condition code information such as carry, parity, auxiliary carry, zero, sign, and overflow. In some examples, the one or more flag registers 3140 are called program status and control registers.

Segment registers 3120 contain segment points for use in accessing memory. In some examples, these registers are referenced by the names CS, DS, SS, ES, FS, and GS.

Machine specific registers (MSRs) 3135 control and report on processor performance. Most MSRs 3135 handle system-related functions and are not accessible to an application program. Machine check registers 3160 consist of control, status, and error reporting MSRs that are used to detect and report on hardware errors.

One or more instruction pointer register(s) 3130 store an instruction pointer value. Control register(s) 3155 (e.g., CR0-CR4) determine the operating mode of a processor (e.g., processor 2770, 2780, 2738, 2715, and/or 2800) and the characteristics of a currently executing task. Debug registers 3150 control and allow for the monitoring of a processor or core's debugging operations.

Memory (mem) management registers 3165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 3100 may, for example, be used in register file/memory ‘ISAB08, or physical register file(s) circuitry 29 58.

Instruction set architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

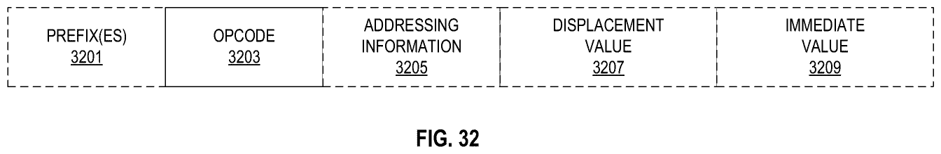

FIG. 32 illustrates examples of an instruction format. As illustrated, an instruction may include multiple components including, but not limited to, one or more fields for: one or more prefixes 3201, an opcode 3203, addressing information 3205 (e.g., register identifiers, memory addressing information, etc.), a displacement value 3207, and/or an immediate value 3209. Note that some instructions utilize some or all the fields of the format whereas others may only use the field for the opcode 3203. In some examples, the order illustrated is the order in which these fields are to be encoded, however, it should be appreciated that in other examples these fields may be encoded in a different order, combined, etc.

The prefix(es) field(s) 3201, when used, modifies an instruction. In some examples, one or more prefixes are used to repeat string instructions (e.g., 0xF0, 0xF2, 0xF3, etc.), to provide section overrides (e.g., 0×2E, 0×36, 0×3E, 0×26, 0×64, 0×65, 0×2E, 0×3E, etc.), to perform bus lock operations, and/or to change operand (e.g., 0×66) and address sizes (e.g., 0×67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 3203 is used to at least partially define the operation to be performed upon a decoding of the instruction. In some examples, a primary opcode encoded in the opcode field 3203 is one, two, or three bytes in length. In other examples, a primary opcode can be a different length. An additional 3-bit opcode field is sometimes encoded in another field.

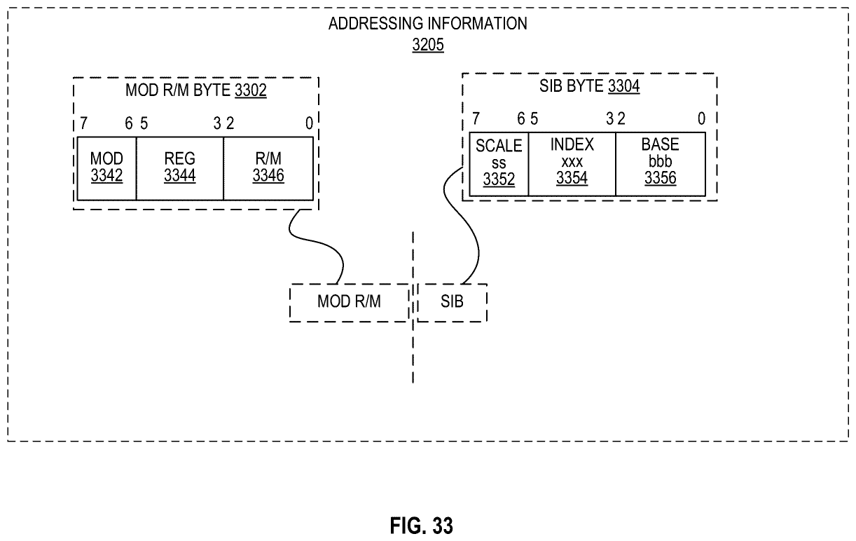

The addressing information field 3205 is used to address one or more operands of the instruction, such as a location in memory or one or more registers. FIG. 33 illustrates examples of the addressing information field 3205. In this illustration, an optional MOD R/M byte 3302 and an optional Scale, Index, Base (SIB) byte 3304 are shown. The MOD R/M byte 3302 and the SIB byte 3304 are used to encode up to two operands of an instruction, each of which is a direct register or effective memory address. Note that both fields are optional in that not all instructions include one or more of these fields. The MOD R/M byte 3302 includes a MOD field 3342, a register (reg) field 3344, and R/M field 3346.

The content of the MOD field 3342 distinguishes between memory access and non-memory access modes. In some examples, when the MOD field 3342 has a binary value of 11 (11b), a register-direct addressing mode is utilized, and otherwise a register-indirect addressing mode is used.

The register field 3344 may encode either the destination register operand or a source register operand or may encode an opcode extension and not be used to encode any instruction operand. The content of register field 3344, directly or through address generation, specifies the locations of a source or destination operand (either in a register or in memory). In some examples, the register field 3344 is supplemented with an additional bit from a prefix (e.g., prefix 3201) to allow for greater addressing.

The R/M field 3346 may be used to encode an instruction operand that references a memory address or may be used to encode either the destination register operand or a source register operand. Note the R/M field 3346 may be combined with the MOD field 3342 to dictate an addressing mode in some examples.

The SIB byte 3304 includes a scale field 3352, an index field 3354, and a base field 3356 to be used in the generation of an address. The scale field 3352 indicates a scaling factor. The index field 3354 specifies an index register to use. In some examples, the index field 3354 is supplemented with an additional bit from a prefix (e.g., prefix 3201) to allow for greater addressing. The base field 3356 specifies a base register to use. In some examples, the base field 3356 is supplemented with an additional bit from a prefix (e.g., prefix 3201) to allow for greater addressing. In practice, the content of the scale field 3352 allows for the scaling of the content of the index field 3354 for memory address generation (e.g., for address generation that uses 2 scale*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 3207 provides this value. Additionally, in some examples, a displacement factor usage is encoded in the MOD field of the addressing information field 3205 that indicates a compressed displacement scheme for which a displacement value is calculated and stored in the displacement field 3207.

In some examples, the immediate value field 3209 specifies an immediate value for the instruction. An immediate value may be encoded as a 1-byte value, a 2-byte value, a 4-byte value, etc.

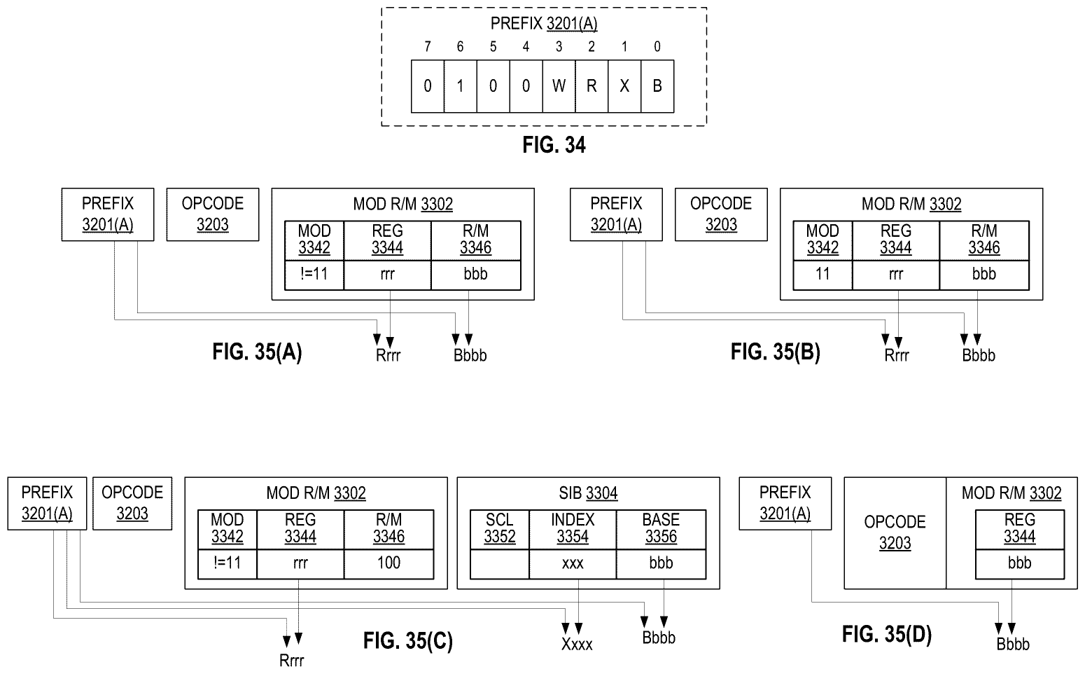

FIG. 34 illustrates examples of a first prefix 3201(A). In some examples, the first prefix 3201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 3201(A) may specify up to three registers using 3-bit fields depending on the format: 1) using the reg field 3344 and the R/M field 3346 of the MOD R/M byte 3302; 2) using the MOD R/M byte 3302 with the SIB byte 3304 including using the reg field 3344 and the base field 3356 and index field 3354; or 3) using the register field of an opcode.

In the first prefix 3201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2+) registers to be addressed, whereas the MOD R/M reg field 3344 and MOD R/M R/M field 3346 alone can each only address 8 registers.

In the first prefix 3201(A), bit position 2 (R) may be an extension of the MOD R/M reg field 3344 and may be used to modify the MOD R/M reg field 3344 when that field encodes a general-purpose register, a 64-bit packed data register (e.g., a SSE register), or a control or debug register. R is ignored when MOD R/M byte 3302 specifies other registers or defines an extended opcode.

Bit position 1 (X) may modify the SIB byte index field 3354.

Bit position 0 (B) may modify the base in the MOD R/M R/M field 3346 or the SIB byte base field 3356; or it may modify the opcode register field used for accessing general purpose registers (e.g., general purpose registers 3125).

FIGS. 35(A)-(D) illustrate examples of how the R, X, and B fields of the first prefix 3201(A) are used. FIG. 35(A) illustrates R and B from the first prefix 3201(A) being used to extend the reg field 3344 and R/M field 3346 of the MOD R/M byte 3302 when the SIB byte 33 04 is not used for memory addressing. FIG. 35(B) illustrates R and B from the first prefix 3201(A) being used to extend the reg field 3344 and R/M field 3346 of the MOD R/M byte 3302 when the SIB byte 33 04 is not used (register-register addressing). FIG. 35(C) illustrates R, X, and B from the first prefix 3201(A) being used to extend the reg field 3344 of the MOD R/M byte 3302 and the index field 3354 and base field 3356 when the SIB byte 33 04 being used for memory addressing. FIG. 35(D) illustrates B from the first prefix 3201(A) being used to extend the reg field 3344 of the MOD R/M byte 3302 when a register is encoded in the opcode 3203.

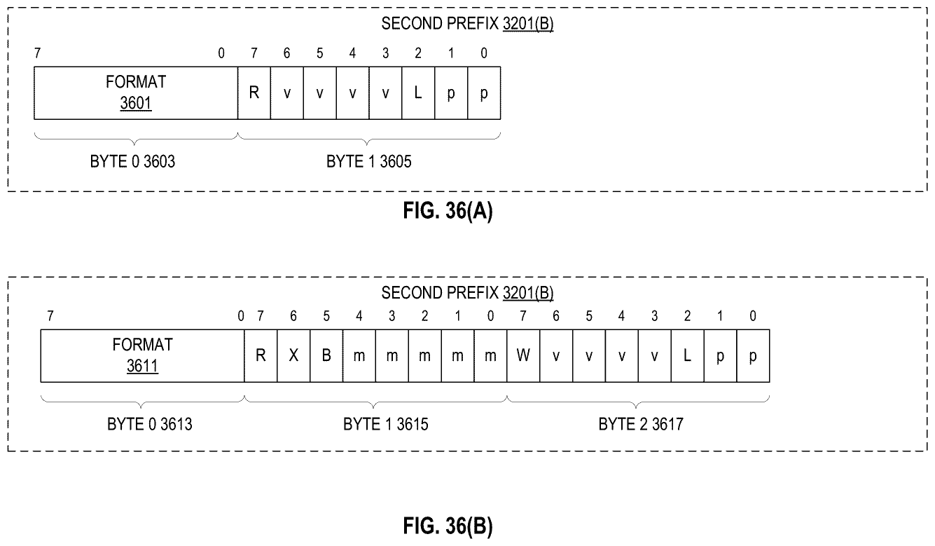

FIGS. 36(A)-(B) illustrate examples of a second prefix 3201(B). In some examples, the second prefix 3201(B) is an example of a VEX prefix. The second prefix 3201(B) encoding allows instructions to have more than two operands, and allows SIMD vector registers (e.g., vector/SIMD registers 3110) to be longer than 64-bits (e.g., 128-bit and 256-bit). The use of the second prefix 3201(B) provides for three-operand (or more) syntax. For example, previous two-operand instructions performed operations such as A=A+B, which overwrites a source operand. The use of the second prefix 3201(B) enables operands to perform nondestructive operations such as A=B+C.

In some examples, the second prefix 3201(B) comes in two forms—a two-byte form and a three-byte form. The two-byte second prefix 3201(B) is used mainly for 128-bit, scalar, and some 256-bit instructions; while the three-byte second prefix 3201(B) provides a compact replacement of the first prefix 3201(A) and 3-byte opcode instructions.

FIG. 36(A) illustrates examples of a two-byte form of the second prefix 3201(B). In one example, a format field 3601 (byte 0 3603) contains the value C5H. In one example, byte 1 3605 includes an “R” value in bit[7]. This value is the complement of the “R” value of the first prefix 3201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 3346 to encode the instruction operand that references a memory address or encode either the destination register operand or a source register operand.

Instructions that use this prefix may use the MOD R/M reg field 3344 to encode either the destination register operand or a source register operand, or to be treated as an opcode extension and not used to encode any instruction operand.

For instruction syntax that supports four operands, vvvv, the MOD R/M R/M field 3346 and the MOD R/M reg field 3344 encode three of the four operands. Bits[7:4] of the immediate value field 3209 are then used to encode the third source register operand.

FIG. 36(B) illustrates examples of a three-byte form of the second prefix 3201(B). In one example, a format field 3611 (byte 0 3613) contains the value C4H. Byte 1 3615 includes in bits[7:5] “R,” “X,” and “B” which are the complements of the same values of the first prefix 3201(A). Bits[4:0] of byte 1 3615 (shown as mmmmm) include content to encode, as need, one or more implied leading opcode bytes. For example, 00001 implies a OFH leading opcode, 00010 implies a OF38H leading opcode, 00011 implies a OF3AH leading opcode, etc.

Bit[7] of byte 2 3617 is used like W of the first prefix 3201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10-F3H, and 11=F2H). Bits[6:3], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

Instructions that use this prefix may use the MOD R/M R/M field 3346 to encode the instruction operand that references a memory address or encode either the destination register operand or a source register operand.

Instructions that use this prefix may use the MOD R/M reg field 3344 to encode either the destination register operand or a source register operand, or to be treated as an opcode extension and not used to encode any instruction operand.

For instruction syntax that supports four operands, vvvv, the MOD R/M R/M field 3346, and the MOD R/M reg field 3344 encode three of the four operands. Bits[7:4] of the immediate value field 3209 are then used to encode the third source register operand.

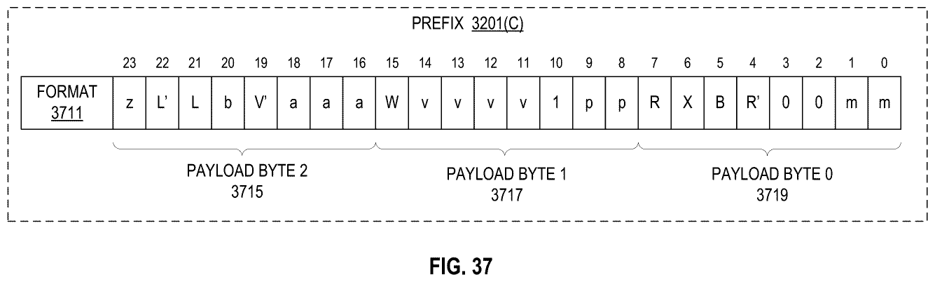

FIG. 37 illustrates examples of a third prefix 3201(C). In some examples, the third prefix 3201(C) is an example of an EVEX prefix. The third prefix 3201(C) is a four-byte prefix.

The third prefix 3201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 31) or predication utilize this prefix. Opmask register allows for conditional processing or selection control. Opmask instructions, whose source/destination operands are opmask registers and treat the content of an opmask register as a single value, are encoded using the second prefix 3201(B).

The third prefix 3201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 3201(C) is a format field 3711 that has a value, in one example, of 62H. Subsequent bytes are referred to as payload bytes 3715-3719 and collectively form a 24-bit value of P[23:0] providing specific capability in the form of one or more fields (detailed herein).

In some examples, P[1:0] of payload byte 3719 are identical to the low two mm bits. P[3:2] are reserved in some examples. Bit P[4] (R′) allows access to the high 16 vector register set when combined with P[7] and the MOD R/M reg field 3344. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 3344 and MOD R/M R/M field 3346. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in Is complement form for certain vector shifts; or 3) not encode any operand, the field is reserved and should contain a certain value, such as 1111b.

P[15] is like W of the first prefix 3201(A) and second prefix 3211(B) and may serve as an opcode extension bit or operand size promotion.

P[18:16] specify the index of a register in the opmask (writemask) registers (e.g., writemask/predicate registers 3115). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 3201(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or Destination |
| RM | X | B | MOD R/M | GPR, Vector | 1st Source or Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

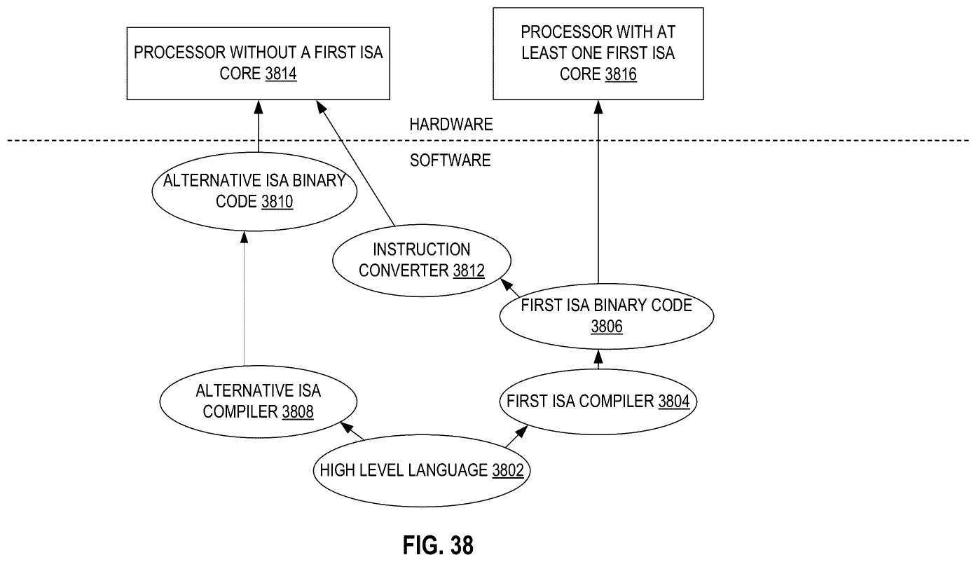

FIG. 38 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 38 shows a program in a high-level language 3802 may be compiled using a first ISA compiler 3804 to generate first ISA binary code 3806 that may be natively executed by a processor with at least one first ISA core 3816. The processor with at least one first ISA core 3816 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 3804 represents a compiler that is operable to generate the first ISA binary code 3806 (e.g., object code) that can, with or without additional linkage processing, be executed on the processor with at least one first ISA core 3816. Similarly, FIG. 38 shows the program in the high-level language 3802 may be compiled using an alternative ISA compiler 3808 to generate alternative ISA binary code 3810 that may be natively executed by a processor without a first ISA core 3814. The instruction converter 3812 is used to convert the first ISA binary code 3806 into code that may be natively executed by the processor without a first ISA core 3814. This converted code is not necessarily to be the same as the alternative ISA binary code 3810; however, the converted code will accomplish the general operation and be made up of instructions from the alternative ISA. Thus, the instruction converter 3812 represents software, firmware, hardware, or a combination thereof that, through emulation, simulation, or any other process, allows a processor or other electronic device that does not have a first ISA processor or core to execute the first ISA binary code 3806.

Components, features, and details described for any of FIGS. 23-27 may also optionally apply to any of FIGS. 21-22. Components, features, and details described for any of the processors disclosed herein (e.g., processor 2210) may optionally apply to any of the methods disclosed herein (e.g., method 2100), which in embodiments may optionally be performed by and/or with such processors. Any of the processors described herein (e.g., processor 2210) in embodiments may optionally be included in any of the systems disclosed herein. Any of the processors disclosed herein (e.g., processor 2210) may optionally have any of the microarchitectures shown herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.

Example 1 is a method including multiplying pairs of corresponding small-exponent floating-point data elements to generate corresponding small-exponent floating-point products. The small-exponent floating-point data elements and the small-exponent floating-point products each have no more than six exponent bits. The method also includes converting the small-exponent floating-point products to signed fixed-point products, and accumulating the signed fixed-point products and an optional signed fixed-point accumulation value by fixed-point addition to generate a signed fixed-point accumulation value.

Example 2 includes the method of Example 1, where each of the small-exponent floating-point data elements is selected from a group consisting of FP16, BF8, HF8, FP6_E3M2, FP6_E2M3, FP4_E2M1, FP4_E3M0, and any combination thereof.

Example 3 includes the method of any one of Examples 1 to 2, where the small-exponent floating-point products are converted to the signed fixed-point products with no loss in precision.

Example 4 includes the method of any one of Examples 1 to 3, where the signed fixed-point products and the optional signed fixed-point accumulation value are to be accumulated with no loss in precision.

Example 5 includes the method of any one of Examples 1 to 4, further including converting the signed fixed-point accumulation value to a floating-point accumulation value, including performing floating-point rounding.

Example 6 includes the method of Example 5, where the floating-point accumulation value has more exponent bits than each of the small-exponent floating-point products.

Example 7 includes the method of any one of Examples 5 to 6, where the floating-point accumulation value has either a single-precision floating-point format, a double-precision floating-point format, or a BFloat16 format.

Example 8 includes the method of any one of Examples 1 to 7, where said multiplying, converting, and accumulating are performed as part of matrix multiplication.

Example 9 includes the method of any one of Examples 1 to 8, where accumulating the signed fixed-point products and the optional signed fixed-point accumulation value is optionally performed without performing exponent difference calculations, optionally without performing maximum exponent calculations, and optionally without performing floating-point rounding.

Example 10 is a processor including a first source storage location to store a first source operand having a first plurality of small-exponent floating-point data elements and a second source storage location to store a second source operand having a second plurality of small-exponent floating-point data elements. The processor also includes circuitry coupled with the first source storage location and coupled with the second source storage location. The circuitry is to multiply each of the first plurality of small-exponent floating-point data elements by one of the second plurality of small-exponent floating-point data elements to generate a plurality of small-exponent floating-point products. The first and second pluralities of small-exponent floating-point data elements and the plurality of small-exponent floating-point products each have no more than six exponent bits. The circuitry is also to convert the small-exponent floating-point products to signed fixed-point products, and accumulate the signed fixed-point products and an optional signed fixed-point accumulation value by fixed-point addition to generate a signed fixed-point accumulation value.

Example 11 includes the processor of Example 10, where each of the small-exponent floating-point data elements is selected from a group consisting of FP16, BF8, HF8, FP6_E3M2, FP6_E2M3, FP4_E2M1, FP4_E3M0, and any combination thereof.

Example 12 includes the processor of any one of Examples 10 to 11, where the circuitry is to convert the small-exponent floating-point products to the signed fixed-point products with no loss in precision.

Example 13 includes the processor of any one of Examples 10 to 12, where the circuitry is to accumulate the signed fixed-point products and the optional signed fixed-point accumulation value with no loss in precision.

Example 14 includes the processor of any one of Examples 10 to 13, where the circuitry is further to convert the signed fixed-point accumulation value to a floating-point accumulation value, including to perform floating-point rounding.

Example 15 includes the processor of Example 14, where the circuitry is to convert the signed fixed-point accumulation value to the floating-point accumulation value, which is to have more exponent bits than each of the small-exponent floating-point products.

Example 16 includes the processor of any one of Examples 14 to 15, where the circuitry is to convert the signed fixed-point accumulation value to the floating-point accumulation value, which has either a single-precision floating-point format, a double-precision floating-point format, or a BFloat16 format.

Example 17 includes the processor of any one of Examples 10 to 16, further including an instruction unit to receive an instruction, and where the circuitry includes execution circuitry to said multiply, said convert, and said accumulate based on the instruction, and where the circuitry includes a fixed-point adder to accumulate the signed fixed-point products and the optional signed fixed-point accumulation value.

Example 18 is a system including a dynamic random access memory (DRAM) and a processor coupled with the DRAM. The processor includes a first source storage location to store a first source operand having a first plurality of small-exponent floating-point data elements and a second source storage location to store a second source operand having a second plurality of small-exponent floating-point data elements. The processor also includes circuitry coupled with the first source storage location and coupled with the second source storage location. The circuitry is to multiply each of the first plurality of small-exponent floating-point data elements by one of the second plurality of small-exponent floating-point data elements to generate a plurality of small-exponent floating-point products. The first and second pluralities of small-exponent floating-point data elements and the plurality of small-exponent floating-point products each have no more than six exponent bits. The circuitry is also to convert the small-exponent floating-point products to signed fixed-point products and accumulate the signed fixed-point products and an optional signed fixed-point accumulation value by fixed-point addition to generate a signed fixed-point accumulation value.

Example 19 includes the system of Example 18, where each of the small-exponent floating-point data elements is selected from a group consisting of FP16, BF8, HF8, FP6_E3M2, FP6_E2M3, FP4_E2M1, FP4_E3M0, and any combination thereof.

Example 20 includes the system of any one of Examples 18 to 19, where the circuitry is further to convert the signed fixed-point accumulation value to a floating-point accumulation value, including to perform floating-point rounding.

Example 21 is a processor or other apparatus operative to perform the method of any one of Examples 1 to 9.

Example 22 is a processor or other apparatus that includes means for performing the method of any one of Examples 1 to 9.

Example 23 is a processor or other apparatus that includes any combination of modules and/or units and/or logic and/or circuitry and/or means operative to perform the method of any one of Examples 1 to 9.

Example 24 is an optionally non-transitory and/or optionally tangible machine-readable medium, which optionally stores or otherwise provides instructions that if and/or when executed by a processor, computer system, electronic device, or other machine, are operative to cause the machine to perform the method of any one of Examples 1 to 9.

What is claimed is:

1. A processor comprising:
a first source storage location to store a first source operand having a first plurality of small-exponent floating-point data elements;
a second source storage location to store a second source operand having a second plurality of small-exponent floating-point data elements; and
circuitry coupled with the first source storage location and coupled with the second source storage location, the circuitry to:
multiply each of the first plurality of small-exponent floating-point data elements by one of the second plurality of small-exponent floating-point data elements to generate a plurality of small-exponent floating-point products, wherein the first and second pluralities of small-exponent floating-point data elements and the plurality of small-exponent floating-point products each have no more than six exponent bits;
convert the small-exponent floating-point products to signed fixed-point products by shifting the small-exponent floating-point products by amounts that convert them to the signed fixed-point products with no loss in precision; and
accumulate the signed fixed-point products and an optional signed fixed-point accumulation value by fixed-point addition to generate a signed fixed-point accumulation value.

2. The processor of claim 1, wherein the circuitry is to convert the small-exponent floating-point products to the signed fixed-point products by shifting the small-exponent floating-point products by the amounts that are based on exponents and dynamic ranges of the small-exponent floating-point data elements used to generate the small-exponent floating-point products.

3. The processor of claim 1, wherein the circuitry is to convert the small-exponent floating-point products to the signed fixed-point products by shifting the small-exponent floating-point products by the amounts that are sums of exponents of the small-exponent floating-point data elements used to generate the small-exponent floating-point products and offsets representative of smallest denormal values that can be represented by the small-exponent floating-point data elements used to generate the small-exponent floating-point products.

4. The processor of claim 1, wherein each of the small-exponent floating-point data elements is selected from a group consisting of FP16, BF8, HF8, FP6_E3M2, FP6_E2M3, FP4_E2M1, FP4_E3M0, and any combination thereof.

5. The processor of claim 1, wherein the circuitry is to convert the small-exponent floating-point products to the signed fixed-point products with no loss in precision.

6. The processor of claim 1, wherein the circuitry is to accumulate the signed fixed-point products and the optional signed fixed-point accumulation value with no loss in precision.

7. The processor of claim 1, wherein the circuitry is further to convert the signed fixed-point accumulation value to a floating-point accumulation value, including to perform floating-point rounding.

8. The processor of claim 7, wherein the circuitry is to convert the signed fixed-point accumulation value to the floating-point accumulation value, which is to have more exponent bits than each of the small-exponent floating-point products.

9. The processor of claim 7, wherein the circuitry is to convert the signed fixed-point accumulation value to the floating-point accumulation value, which has either a single-precision floating-point format, a double-precision floating-point format, or a BFloat16 format.

10. The processor of claim 1, further comprising an instruction unit to receive an instruction, and wherein the circuitry comprises execution circuitry to said multiply, said convert, and said accumulate based on the instruction, and wherein the circuitry includes a fixed-point adder to accumulate the signed fixed-point products and the optional signed fixed-point accumulation value.

11. A system comprising:
a dynamic random access memory (DRAM); and
a processor coupled with the DRAM, the processor comprising:
a first source storage location to store a first source operand having a first plurality of small-exponent floating-point data elements;
a second source storage location to store a second source operand having a second plurality of small-exponent floating-point data elements; and
circuitry coupled with the first source storage location and coupled with the second source storage location, the circuitry to:
multiply each of the first plurality of small-exponent floating-point data elements by one of the second plurality of small-exponent floating-point data elements to generate a plurality of small-exponent floating-point products, wherein the first and second pluralities of small-exponent floating-point data elements and the plurality of small-exponent floating-point products each have no more than six exponent bits;
convert the small-exponent floating-point products to signed fixed-point products by shifting the small-exponent floating-point products by amounts that convert them to the signed fixed-point products with no loss in precision; and
accumulate the signed fixed-point products and an optional signed fixed-point accumulation value by fixed-point addition to generate a signed fixed-point accumulation value.

12. The system of claim 11, wherein the circuitry is to convert the small-exponent floating-point products to the signed fixed-point products by shifting the small-exponent floating-point products by the amounts that are based on exponents and dynamic ranges of the small-exponent floating-point data elements used to generate the small-exponent floating-point products.

13. The system of claim 11, wherein the circuitry is to convert the small-exponent floating-point products to the signed fixed-point products by shifting the small-exponent floating-point products by the amounts that are sums of exponents of the small-exponent floating-point data elements used to generate the small-exponent floating-point products and offsets representative of smallest denormal values that can be represented by the small-exponent floating-point data elements used to generate the small-exponent floating-point products.

14. The system of claim 11, wherein each of the small-exponent floating-point data elements is selected from a group consisting of FP16, BF8, HF8, FP6_E3M2, FP6_E2M3, FP4_E2M1, FP4_E3M0, and any combination thereof.

15. The system of claim 11, wherein the circuitry is to accumulate the signed fixed-point products and the optional signed fixed-point accumulation value with no loss in precision.

16. The system of claim 11, wherein the circuitry is further to convert the signed fixed-point accumulation value to a floating-point accumulation value, including to perform floating-point rounding.

17. The system of claim 16, wherein the circuitry is to convert the signed fixed-point accumulation value to the floating-point accumulation value, which is to have more exponent bits than each of the small-exponent floating-point products.

18. The system of claim 16, wherein the circuitry is to convert the signed fixed-point accumulation value to the floating-point accumulation value, which has either a single-precision floating-point format, a double-precision floating-point format, or a BFloat16 format.

19. The system of claim 16, further comprising an instruction unit to receive an instruction, and wherein the circuitry comprises execution circuitry to said multiply, said convert, and said accumulate based on the instruction.

20. A method comprising:
multiplying pairs of corresponding small-exponent floating-point data elements to generate corresponding small-exponent floating-point products, wherein the small-exponent floating-point data elements and the small-exponent floating-point products each have no more than six exponent bits;
converting the small-exponent floating-point products to signed fixed-point products by shifting the small-exponent floating-point products by amounts that convert them to the signed fixed-point products with no loss in precision; and
accumulating the signed fixed-point products and an optional signed fixed-point accumulation value by fixed-point addition to generate a signed fixed-point accumulation value.
